(19) United States
(12) Patent Application Publication
(10) Pub. No.: US 2024/0199204 A1
(43) Pub. Date: Jun. 20, 2024

(54) MANNED VERTICAL TAKE-OFF AND LANDING AERIAL VEHICLE NAVIGATION

(71) Applicant: ALAUDA AERONAUTICS PTY LTD, Beverley (AU)

(72) Inventors: Matthew James PEARSON, Beverley (AU); Florian BREUT, Beverley (AU)

(73) Assignee: ALAUDA AERONAUTICS PTY LTD, Beverley (AU)

(21) Appl. No.: 18/546,834

(22) PCT Filed: Feb. 17, 2022
(86) PCT No.: PCT/AU2022/050111

§ 371 Date: Dec. 8, 2023

(30) Foreign Application Priority Data
Feb. 17, 2021 (AU) 2021900405

(51) Int. Cl. B64C 29/00; G01C 21/16; G01S 7/48; G01S 19/48; G05D 1/46; G05D 1/622

(52) U.S. Cl. CPC B64C 29/0016; G01C 21/165; G01S 7/4808; G01S 19/485; G05D 1/46; G05D 1/622

(57) ABSTRACT

Some embodiments relate to a manned vertical take-off and landing (VTOL) aerial vehicle (AV) and to methods relating to such VTOL AVs. An example vehicle comprises: a body comprising a cockpit; a propulsion system carried by the body to propel the body during flight; pilot-operable controls accessible from the cockpit; a sensing system configured to generate sensor data associated with a region around the manned VTOL AV; a control system configured to enable control of the manned VTOL AV to be shared between a pilot and an autonomous piloting system, wherein the control system may utilise the sensor data; and a three-dimensional model of the region; and program instructions to: determine a state estimate and a state estimate confidence metric; generate a three-dimensional point cloud of the region; generate a plurality of virtual particles within the three-dimensional model; compute a plurality of scores, each score being associated with one of the plurality of virtual particles; and update the state estimate based at least in part on the computed scores, thereby determining an updated state estimate.

### TECHNICAL FIELD

Embodiments of this disclosure generally relate to aerial vehicles. In particular, embodiments of this disclosure relate to navigation of manned vertical take-off and landing aerial vehicles.

### BACKGROUND

Aerial vehicles, such as manned vertical take-off and landing (VTOL) aerial vehicles can be controllably propelled within three-dimensional space. In some cases, a manned VTOL aerial vehicle can, for example, be controllably propelled within three-dimensional space that is physically restricted (e.g. indoors) or between walls or other objects. Alternatively, the manned VTOL aerial vehicle can be controllably propelled within artificially restricted three-dimensional space, for example, at heights dictated by an air-traffic controller, or other artificial restriction.

Manned VTOL aerial vehicles may also collide with objects such as birds, walls, buildings or other aerial vehicles during flight. Collision with an object can cause damage to the aerial vehicle, particularly when the aerial vehicle is traveling at a high speed. Furthermore, collisions can be dangerous to people or objects nearby that can be hit by debris or the aerial vehicle itself. This can be a particularly large issue when high density airspace is considered.

A relatively large amount of aerial vehicles may occupy similar airspace and may travel along transverse flightpaths, increasing risks associated with collisions. Furthermore, manned aerial vehicles may also collide with objects because of other factors such as poor visibility, pilot error or slow pilot reaction time.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

In some embodiments, there is provided a manned VTOL aerial vehicle. The manned VTOL aerial vehicle may comprise: a body comprising a cockpit; a propulsion system carried by the body to propel the body during flight; pilot-operable controls accessible from the cockpit; a sensing system configured to generate sensor data associated with a region around the manned VTOL aerial vehicle and a control system configured to enable control of the manned VTOL aerial vehicle to be shared between a pilot and an autonomous piloting system. The control system may comprise: at least one processor; and memory accessible to the at least one processor. The memory may be configured to store: the sensor data; and a three-dimensional model of the region. The memory may store program instructions accessible by the at least one processor, and configured to cause the at least one processor to: determine a state estimate and a state estimate confidence metric, wherein: the state estimate is indicative of a state of the manned VTOL aerial vehicle within the three-dimensional model; the state estimate confidence metric is indicative of an error associated with the state estimate; and the state estimate comprises: a position estimate that is indicative of a position of the manned VTOL aerial vehicle within the three-dimensional model; a speed vector that is indicative of a velocity of the manned VTOL aerial vehicle; and an attitude vector that is indicative of an attitude of the manned VTOL aerial vehicle; generate a three-dimensional point cloud of the region based at least in part on the sensor data; generate a plurality of virtual particles within the three-dimensional model at particle positions that are around the state estimate, wherein the particle positions are determined based at least in part on the state estimate confidence metric; compute a plurality of scores, each score being associated with one of the plurality of virtual particles and being indicative of a difference between the three-dimensional model and the three-dimensional point cloud when the three-dimensional point cloud is centred on the respective virtual particle; and update the state estimate based at least in part on the computed scores, thereby determining an updated state estimate.

In some embodiments, the region comprises an object; and the program instructions are further configured to cause the at least one processor to control the propulsion system such that the manned VTOL aerial vehicle avoids colliding with the object, based at least in part on the updated state estimate.

In some embodiments, the sensing system comprises a Global Navigation Satellite System (GNSS) module configured to generate GNSS data that is indicative of a latitude and a longitude of the manned VTOL aerial vehicle; and the sensor data comprises the GNSS data.

In some embodiments, determining the state estimate comprises determining the GNSS data; and determining the state estimate based at least in part on the GNSS data.

In some embodiments, the sensing system comprises one or more of: an altimeter configured to provide, to the at least one processor, altitude data that is indicative of an altitude of the manned VTOL aerial vehicle; an accelerometer configured to provide, to the at least one processor, accelerometer data that is indicative of an acceleration of the manned VTOL aerial vehicle; a gyroscope configured to provide, to the at least one processor, gyroscopic data that is indicative of an orientation of the manned VTOL aerial vehicle; and a magnetometer sensor configured to provide, to the at least one processor, magnetic field data that is indicative of an azimuth orientation of the manned VTOL aerial vehicle.

In some embodiments, the sensor data comprises one or more of the altitude data, the acceleration data, the gyroscopic data and the magnetic field data.

In some embodiments, determining the state estimate comprises: determining one or more of the altitude data, accelerometer data, gyroscopic data and magnetic field data; and determining the state estimate based at least in part on one or more of the altitude data, accelerometer data, gyroscopic data and magnetic field data.

In some embodiments, the sensing system comprises an imaging module configured to provide, to the at least one processor, image data that is associated with the region; and the sensor data comprises the image data.

In some embodiments, the imaging module comprises one or more of: a light detection and ranging (LIDAR) module configured to generate LIDAR data; a visible spectrum imaging module configured to generate visible spectrum image data; and a radio detecting and ranging (RADAR) module configured to generate RADAR data.

In some embodiments, the image data comprises one or more of the LIDAR data, the visible image data and the RADAR data.

In some embodiments, determining the state estimate comprises determining one or more of the LIDAR data, visible spectrum image data and RADAR data; and determining the state estimate based at least part on one or more of the LIDAR data, visible spectrum image data and RADAR data.

In some embodiments, determining the state estimate and the state estimate confidence metric comprises visual odometry.

In some embodiments, determining the state estimate comprises: determining a longitudinal velocity estimate that is indicative of a longitudinal velocity of the manned VTOL aerial vehicle, based at least in part on image data captured by a ground-facing camera mounted on the manned VTOL aerial vehicle; determining an acceleration estimate that is indicative of an acceleration of the manned VTOL aerial vehicle, based at least in part on accelerometer data; determining an orientation estimate that is indicative of an orientation of the manned VTOL aerial vehicle, based at least in part on gyroscopic data; determining an azimuth orientation estimate of the manned VTOL aerial vehicle, based at least in part on magnetic field data; and determining an altitude estimate that is indicative of an altitude of the manned VTOL aerial vehicle, based at least in part on altitude data.

In some embodiments, determining the state estimate comprises: determining an egomotion estimate, based at least in part on image data captured by a forward-facing camera mounted on the manned VTOL aerial vehicle; determining an acceleration estimate that is indicative of an acceleration of the manned VTOL aerial vehicle, based at least in part on accelerometer data; determining an orientation estimate that is indicative of an orientation of the manned VTOL aerial vehicle, based at least in part on gyroscopic data; determining an azimuth orientation estimate of the manned VTOL aerial vehicle, based at least in part on magnetic field data; and determining an altitude estimate that is indicative of an altitude of the manned VTOL aerial vehicle, based at least in part on altitude data.

In some embodiments, the program instructions are further configured to cause the at least one processor to receive external sensing system data generated by an external sensing system.

In some embodiments, the external sensing system data comprises the state estimate and the state estimate confidence metric; and determining the state estimate and the state estimate confidence metric comprises receiving the external sensing system data.

In some embodiments, the external sensing system data comprises external sensing system image data; and the state estimate and the state estimate confidence metric are determined based at least in part on the external sensing system image data.

In some embodiments, generating the three-dimensional point cloud comprises: generating a depth map based at least in part on the visible spectrum image data, wherein the depth map is generated using a deep neural network (DNN); and merging the depth map and the LIDAR data.

In some embodiments, outlier points of the depth map and/or the LIDAR data are excluded from the three-dimensional point cloud.

In some embodiments, determining the state estimate and the state estimate confidence metric comprises using an Extended Kalman Filter.

In some embodiments, the virtual particles are generated such that a distance between adjacent particle positions is equal.

In some embodiments, a weight is associated with each virtual particle, the weight being related to a particle confidence metric associated with the respective particle.

In some embodiments, computing one of the plurality of scores comprises determining a comparison metric for each point of the three-dimensional point cloud, wherein the comparison metric is indicative of a distance between the respective point of the three-dimensional point cloud and a comparison point of the three-dimensional model.

In some embodiments, determining the comparison metric for a point of the three-dimensional point cloud comprises: projecting a ray from the respective particle position to the point of the three-dimensional point cloud; and determining a distance between the point of the three-dimensional point cloud and a point of the three-dimensional model that is intersected by the ray.

In some embodiments, computing the score for one or more of the virtual particles comprises summing the comparison metrics of each of the points of the three-dimensional point cloud when the three-dimensional point cloud is centred on the relevant virtual particle.

In some embodiments, updating the state estimate based at least in part on the computed scores comprises: determining a minimised virtual particle; wherein: the minimised virtual particle is one of the plurality of virtual particles; and the score associated with the minimised virtual particle is lower than the scores associated with the other virtual particles of the plurality of virtual particles; and setting the state estimate to correspond to the minimised virtual particle.

In some embodiments, the program instructions are further configured to cause the at least one processor to determine an object state estimate that is indicative of a state of the object.

In some embodiments, the object state estimate comprises: an object position estimate that is indicative of a position of the object within the region; an object speed vector that is indicative of a velocity of the object; and an object attitude vector that is indicative of an attitude of the object.

In some embodiments, the program instructions are further configured to cause the at least one processor to control the propulsion system such that the manned VTOL aerial vehicle avoids colliding with the object, based at least in part on the updated position estimate and the object position estimate.

In some embodiments, the program instructions are further configured to cause the at least one processor to receive the three-dimensional model from another computing device.

In some embodiments, there is provided a computer-implemented method for determining an updated state estimate of a manned VTOL aerial vehicle. The computer-implemented method may comprise: determining a state estimate and a state estimate confidence metric, wherein: the state estimate is indicative of a state of the manned VTOL aerial vehicle within a three-dimensional model of a region; the state estimate confidence metric is indicative of an error associated with the state estimate; and the state estimate comprises: a position estimate that is indicative of a position of the manned VTOL aerial vehicle within the three-dimensional model; a speed vector that is indicative of a velocity of the manned VTOL aerial vehicle; and an attitude vector that is indicative of an attitude of the manned VTOL aerial vehicle; generating a three-dimensional point cloud of the region based at least in part on sensor data generated by a sensing system of the manned VTOL aerial vehicle; generating a plurality of virtual particles within the three-dimensional model at particle positions that are around the state estimate, wherein the particle positions are determined based at least in part on the state estimate confidence metric; computing a plurality of scores, each score being associated with one of the plurality of virtual particles and being indicative of a difference between the three-dimensional model and the three-dimensional point cloud when the three-dimensional point cloud is centred on the respective virtual particle; and updating the state estimate based at least in part on the computed scores, thereby determining an updated state estimate.

In some embodiments, the region comprises an object; and the computer-implemented method further comprises controlling a propulsion system of the manned VTOL aerial vehicle such that the manned VTOL aerial vehicle avoids colliding with the object, based at least in part on the updated state estimate.

In some embodiments, the sensor data comprises one or more of: GNSS data that is indicative of a latitude and a longitude of the manned VTOL aerial vehicle; altitude data that is indicative of an altitude of the manned VTOL aerial vehicle; accelerometer data that is indicative of an acceleration of the manned VTOL aerial vehicle; gyroscopic data that is indicative of an orientation of the manned VTOL aerial vehicle; and magnetic field data that is indicative of an azimuth orientation of the manned VTOL aerial vehicle.

In some embodiments, the state estimate and the state estimate confidence metric are determined based at least in part on one or more of the GNSS data, the altitude data, the accelerometer data, the gyroscopic data and the magnetic field data.

In some embodiments, the sensor data comprises one or more of LIDAR data, visible spectrum image data and RADAR data.

In some embodiments, the state estimate and the state estimate metric are determined based at least in part on one or more of the LIDAR data, the visible spectrum image data and the RADAR data.

In some embodiments, determining the state estimate and the state estimate confidence metric comprises visual odometry.

In some embodiments, determining the state estimate comprises: determining a longitudinal velocity estimate that is indicative of a longitudinal velocity of the VTOL aerial vehicle, based at least in part on image data captured by a ground-facing camera mounted on the VTOL aerial vehicle; determining an acceleration estimate that is indicative of an acceleration of the VTOL aerial vehicle, based at least in part on accelerometer data; determining an orientation estimate that is indicative of an orientation of the VTOL aerial vehicle, based at least in part on gyroscopic data; determining an azimuth orientation estimate of the manned VTOL aerial vehicle, based at least in part on magnetic field data; and determining an altitude estimate that is indicative of an altitude of the manned VTOL aerial vehicle, based at least in part on altitude data.

In some embodiments, determining the state estimate comprises: determining an egomotion estimate, based at least in part on image data captured by a forward-facing camera mounted on the VTOL aerial vehicle; determining an acceleration estimate that is indicative of an acceleration of the VTOL aerial vehicle, based at least in part on accelerometer data; determining an orientation estimate that is indicative of an orientation of the VTOL aerial vehicle, based at least in part on gyroscopic data; determining an azimuth orientation estimate of the manned VTOL aerial vehicle, based at least in part on magnetic field data; and determining an altitude estimate that is indicative of an altitude of the manned VTOL aerial vehicle, based at least in part on altitude data.

In some embodiments, the method further comprises receiving external sensing system data generated by an external sensing system.

In some embodiments, the external sensing system data comprises the state estimate and the state estimate confidence metric; and determining the state estimate and the state estimate confidence metric comprises receiving the external sensing system data.

In some embodiments, the external sensing system data comprises external sensing system image data; and the state estimate and the state estimate confidence metric are determined based at least in part on the external sensing system image data.

In some embodiments, generating the three dimensional point cloud comprises: generating a depth map based at least in part on the visible spectrum image data, wherein the depth map is generated using a deep neural network (DNN); and merging the depth map and the LIDAR data.

In some embodiments, outlier points of the depth map and/or the LIDAR data are excluded from the three-dimensional point cloud.

In some embodiments, determining the state estimate and the state estimate confidence metric comprises using an Extended Kalman Filter.

In some embodiments, the virtual particles are generated such that a distance between adjacent particle positions is equal.

In some embodiments, a weight is associated with each virtual particle, the weight being related to a particle confidence metric associated with the respective particle.

In some embodiments, computing one of the plurality of scores comprises determining a comparison metric for each point of the three-dimensional point cloud, wherein the comparison metric is indicative of a distance between the respective point of the three-dimensional point cloud and a comparison point of the three-dimensional model.

In some embodiments, determining the comparison metric for a point of the three-dimensional point cloud comprises: projecting a ray from the respective particle position to the point of the three-dimensional point cloud; and determining a distance between the point of the three-dimensional point cloud and a point of the three-dimensional model that is intersected by the ray.

In some embodiments, computing the score for one or more of the virtual particles comprises summing the comparison metrics of each of the points of the three-dimensional point cloud when the three dimensional point cloud is centred on the relevant virtual particle.

In some embodiments, updating the state estimate based at least in part on the computed scores comprises: determining a minimised virtual particle; wherein: the minimised virtual particle is one of the plurality of virtual particles; and the score associated with the minimised virtual particle is lower than the scores associated with the other virtual particles of the plurality of virtual particles; and setting the state estimate to correspond to the minimised virtual particle.

In some embodiments, the method further comprises determining an object state estimate that is indicative of a state of the object.

In some embodiments, the object state estimate comprises: an object position estimate that is indicative of a position of the object within the region; an object speed vector that is indicative of a velocity of the object; and an object attitude vector that is indicative of an attitude of the object.

In some embodiments, the method further comprises controlling a propulsion system of the manned VTOL aerial vehicle such that the manned VTOL aerial vehicle avoids colliding with the object, based at least in part on the updated state estimate and the object state estimate.

In some embodiments, the method further comprises receiving the three-dimensional model from another computing device.

In some embodiments, there is provided a manned VTOL aerial vehicle. The manned VTOL aerial vehicle may comprise: a body comprising a cockpit; a propulsion system carried by the body to propel the body during flight; pilot-operable controls accessible from the cockpit; a sensing system configured to generate sensor data associated with a region around the manned VTOL aerial vehicle; and a control system configured to enable control of the manned VTOL aerial vehicle to be shared between a pilot and an autonomous piloting system. The control system may comprise: at least one processor; and memory accessible to the at least one processor. The memory may be configured to store the sensor data. The memory may store program instructions accessible by the at least processor. The program instructions may be configured to cause the at least one processor to: determine an initial state estimate indicative of a state of the manned VTOL aerial vehicle within the region at a first time; determine that GNSS data is unavailable; and in response to determining that GNSS data is unavailable: determine a motion estimate that is indicative of motion of the VTOL aerial vehicle between the first time and a second time, based at least in part on the sensor data; and determine an updated state estimate based at least in part on the motion estimate and the initial state estimate.

In some embodiments, the region comprises an object; and the program instructions are further configured to cause the at least one processor to control the propulsion system such that the manned VTOL aerial vehicle avoids colliding with the object, based at least in part on the updated state estimate.

In some embodiments, the initial state estimate comprises: an initial position estimate that is indicative of a position of the manned VTOL aerial vehicle within the region at the first time; an initial speed vector that is indicative of a velocity of the manned VTOL aerial vehicle at the first time; and an initial attitude vector that is indicative of an attitude of the manned VTOL aerial vehicle at the first time.

In some embodiments, the updated state estimate comprises: an updated position estimate that is indicative of an updated position of the manned VTOL aerial vehicle within the region at the second time; an updated speed vector that is indicative of an updated velocity of the manned VTOL aerial vehicle at the second time; and an updated attitude vector that is indicative of an updated attitude of the manned VTOL aerial vehicle at the second time.

In some embodiments, the motion estimate comprises: a motion estimate position estimate that is indicative of a change in position of the manned VTOL aerial vehicle between the first time and the second time; a motion estimate speed vector that is indicative of a change in velocity of the manned VTOL aerial vehicle between the first time and the second time; and a motion estimate attitude estimate that is indicative of a change in attitude of the manned VTOL aerial vehicle between the first time and the second time.

In some embodiments, the sensing system comprises a Global Navigation Satellite System (GNSS) module configured to generate GNSS data that is indicative of a latitude and a longitude of the manned VTOL aerial vehicle; and the sensor data comprises the GNSS data.

In some embodiments, the GNSS data is available at the first time and the GNSS data is unavailable at the second time.

In some embodiments, determining the initial state estimate comprises determining the GNSS data; and determining the initial state estimate based at least in part on the GNSS data.

In some embodiments, the sensing system comprises one or more of: an altimeter configured to provide, to the at least one processor, altitude data that is indicative of an altitude of the manned VTOL aerial vehicle; an accelerometer configured to provide, to the at least one processor, accelerometer data that is indicative of an acceleration of the manned VTOL aerial vehicle; a gyroscope configured to provide, to the at least one processor, gyroscopic data that is indicative of an orientation of the manned VTOL aerial vehicle; and a magnetometer sensor configured to provide, to the at least one processor, magnetic field data that is indicative of an azimuth orientation of the manned VTOL aerial vehicle.

In some embodiments, the sensor data comprises one or more of the altitude data, the acceleration data, the gyroscopic data and the magnetic field data.

In some embodiments, determining the motion estimate comprises: determining one or more of the altitude data, accelerometer data, gyroscopic data and magnetic field data at the first time; determining one or more of the altitude data, accelerometer data, gyroscopic data and magnetic field data at the second time; and determining the motion estimate based at least in part on one or more of the altitude data, accelerometer data, gyroscopic data and magnetic field data at the first time and one or more of the altitude data, accelerometer data, gyroscopic data and magnetic field data at the second time.

In some embodiments, the sensing system comprises an imaging module configured to provide, to the at least one processor, image data that is associated with the region; and the sensor data comprises the image data.

In some embodiments, the imaging module comprises one or more of: a light detection and ranging (LIDAR) module configured to generate LIDAR data; a visible spectrum imaging module configured to generate visible spectrum image data; and a radio detecting and ranging (RADAR) module configured to generate RADAR data.

In some embodiments, the image data comprises one or more of the LIDAR data, the visible image data and the RADAR data.

In some embodiments, determining the motion estimate comprises: determining one or more of the LIDAR data, the visible spectrum image data and the RADAR data at the first time; determining one or more of the LIDAR data, the visible spectrum image data and the RADAR data at the second time; and determining the motion estimate based at least part on one or more of the LIDAR data, the visible spectrum image data and the RADAR data at the first time and one or more of the LIDAR data, the visible spectrum image data and the RADAR data at the second time.

In some embodiments, determining the motion estimate comprises visual odometry.

In some embodiments, determining the motion estimate comprises: determining a longitudinal velocity estimate that is indicative of a longitudinal velocity of the manned VTOL aerial vehicle, based at least in part on image data captured by a ground-facing camera mounted on the manned VTOL aerial vehicle; determining an acceleration estimate that is indicative of an acceleration of the manned VTOL aerial vehicle, based at least in part on accelerometer data; determining an orientation estimate that is indicative of an orientation of the manned VTOL aerial vehicle, based at least in part on gyroscopic data; determining an azimuth orientation estimate of the manned VTOL aerial vehicle, based at least in part on magnetic field data; and determining an altitude estimate that is indicative of an altitude of the manned VTOL aerial vehicle, based at least in part on altitude data.

In some embodiments, determining the motion estimate comprises: determining an egomotion estimate, based at least in part on image data captured by a forward-facing camera mounted on the manned VTOL aerial vehicle; determining an acceleration estimate that is indicative of an acceleration of the manned VTOL aerial vehicle, based at least in part on accelerometer data; determining an orientation estimate that is indicative of an orientation of the manned VTOL aerial vehicle, based at least in part on gyroscopic data; determining an azimuth orientation estimate of the manned VTOL aerial vehicle, based at least in part on magnetic field data; and determining an altitude estimate that is indicative of an altitude of the manned VTOL aerial vehicle, based at least in part on altitude data.

In some embodiments, determining the motion estimate comprises one or more of: determining an egomotion estimate, based at least in part on image data captured by a front-facing camera, the egomotion estimate being indicative of movement of the manned VTOL aerial vehicle between the first time and the second time; determining an acceleration estimate that is indicative of an acceleration of the manned VTOL aerial vehicle between the first time and the second time; determining an orientation change estimate that is indicative of a change in orientation of the manned VTOL aerial vehicle between the first time and the second time; determining an azimuth change estimate that is indicative of a change in the azimuth of the manned VTOL aerial vehicle between the first time and the second time; and determining an altitude change estimate that is indicative of a change in altitude of the manned VTOL aerial vehicle between the first time and the second time; determining the motion estimate based at least in part on the initial state estimate and one or more of the egomotion estimate, the acceleration estimate, the orientation change estimate, the azimuth change estimate and the altitude change estimate.

In some embodiments, determining the updated state estimate comprises adding the motion estimate to the initial state estimate.

In some embodiments, there is provided a computer-implemented method for determining an updated state estimate of a manned VTOL aerial vehicle. The computer-implemented method may comprise: determining an initial state estimate indicative of a state of the manned VTOL aerial vehicle within a region at a first time; determining that GNSS data is unavailable; and in response to determining that GNSS data is unavailable: determining a motion estimate that is indicative of motion of the VTOL aerial vehicle between the first time and a second time, based at least in part on sensor data generated by a sensing system of the manned VTOL aerial vehicle; and determining an updated state estimate based at least in part on the motion estimate and the initial state estimate.

In some embodiments, the region comprises an object; and the computer-implemented method further comprises controlling a propulsion system of the manned VTOL aerial vehicle such that the manned VTOL aerial vehicle avoids colliding with the object, based at least in part on the updated state estimate.

In some embodiments, the initial state estimate comprises: an initial position estimate that is indicative of a position of the manned VTOL aerial vehicle within the region at the first time; an initial speed vector that is indicative of a velocity of the manned VTOL aerial vehicle at the first time; and an initial attitude vector that is indicative of an attitude of the manned VTOL aerial vehicle at the first time.

In some embodiments, wherein the updated state estimate comprises: an updated position estimate that is indicative of an updated position of the manned VTOL aerial vehicle within the region at the second time; an updated speed vector that is indicative of an updated velocity of the manned VTOL aerial vehicle at the second time; and an updated attitude vector that is indicative of an updated attitude of the manned VTOL aerial vehicle at the second time.

In some embodiments, the motion estimate comprises: a motion estimate position estimate that is indicative of a change in position of the manned VTOL aerial vehicle between the first time and the second time; a motion estimate speed vector that is indicative of a change in velocity of the manned VTOL aerial vehicle between the first time and the second time; and a motion estimate attitude estimate that is indicative of a change in attitude of the manned VTOL aerial vehicle between the first time and the second time.

In some embodiments, the sensor data comprises one or more of GNNS data, altitude data, acceleration data, gyroscopic data and magnetic field data.

In some embodiments, the GNSS data is available at the first time and the GNSS data is unavailable at the second time.

In some embodiments, determining the motion estimate comprises: determining one or more of the altitude data, accelerometer data, gyroscopic data and magnetic field data at the first time; determining one or more of the altitude data, accelerometer data, gyroscopic data and magnetic field data at the second time; and determining the motion estimate based at least in part on one or more of the altitude data, accelerometer data, gyroscopic data and magnetic field data at the first time and one or more of the altitude data, accelerometer data, gyroscopic data and magnetic field data at the second time.

In some embodiments, the sensor data comprises image data.

In some embodiments, the image data comprises one or more of LIDAR data, visible spectrum image data and RADAR data.

In some embodiments, determining the motion estimate comprises: determining one or more of the LIDAR data, the visible spectrum image data and the RADAR data at the first time; determining one or more of the LIDAR data, the visible spectrum image data and the RADAR data at the second time; and determining the motion estimate based at least part on one or more of the LIDAR data, the visible spectrum image data and the RADAR data at the first time and one or more of the LIDAR data, the visible spectrum image data and the RADAR data at the second time.

In some embodiments, determining the motion estimate comprises visual odometry.

In some embodiments, determining the motion estimate comprises: determining a longitudinal velocity estimate that is indicative of a longitudinal velocity of the VTOL aerial vehicle, based at least in part on image data captured by a ground-facing camera mounted on the VTOL aerial vehicle; determining an acceleration estimate that is indicative of an acceleration of the VTOL aerial vehicle, based at least in part on accelerometer data; determining an orientation estimate that is indicative of an orientation of the VTOL aerial vehicle, based at least in part on gyroscopic data; determining an azimuth orientation estimate of the manned VTOL aerial vehicle, based at least in part on magnetic field data; and determining an altitude estimate that is indicative of an altitude of the manned VTOL aerial vehicle, based at least in part on altitude data.

In some embodiments, determining the state estimate comprises: determining an egomotion estimate, based at least in part on image data captured by a forward-facing camera mounted on the VTOL aerial vehicle; determining an acceleration estimate that is indicative of an acceleration of the VTOL aerial vehicle, based at least in part on accelerometer data; determining an orientation estimate that is indicative of an orientation of the VTOL aerial vehicle, based at least in part on gyroscopic data; determining an azimuth orientation estimate of the manned VTOL aerial vehicle, based at least in part on magnetic field data; and determining an altitude estimate that is indicative of an altitude of the manned VTOL aerial vehicle, based at least in part on altitude data.

In some embodiments, determining the motion estimate comprises one or more of: determining an egomotion estimate, based at least in part on image data captured by a front-facing camera, the egomotion estimate being indicative of movement of the manned VTOL aerial vehicle between the first time and the second time; determining an acceleration estimate that is indicative of an acceleration of the VTOL aerial vehicle between the first time and the second time; determining an orientation change estimate that is indicative of a change in orientation of the VTOL aerial vehicle between the first time and the second time; determining an azimuth change estimate that is indicative of a change in the azimuth of the VTOL aerial vehicle between the first time and the second time; and determining an altitude change estimate that is indicative of a change in altitude of the manned VTOL aerial vehicle between the first time and the second time; determining the motion estimate based at least in part on the initial state estimate and one or more of the egomotion estimate, the acceleration estimate, the orientation change estimate, the azimuth change estimate and the altitude change estimate.

In some embodiments, determining the updated state estimate comprises adding the motion estimate to the initial state estimate.

### BRIEF DESCRIPTION OF DRAWINGS

Embodiments of the present disclosure will now be described in further detail, by way of non-limiting example, with reference to the accompanying drawings, in which:

FIG. 1 illustrates a front perspective view of a manned VTOL aerial vehicle, according to some embodiments;

FIG. 2 illustrates a rear perspective view of the manned VTOL aerial vehicle, according to some embodiments;

FIG. 3 is a block diagram of an aerial vehicle system, according to some embodiments;

FIG. 4 is a block diagram of a control system of the manned VTOL aerial vehicle, according to some embodiments;

FIG. 5 is a block diagram of an alternative control system of the manned VTOL aerial vehicle, according to some embodiments;

FIG. 6 is a block diagram of a sensing system of the manned VTOL aerial vehicle, according to some embodiments;

FIG. 7 illustrates a front perspective view of a manned VTOL aerial vehicle, showing example positions of a plurality of sensors of a sensing module, according to some embodiments;

FIG. 8 is a process flow diagram of a computer-implemented method for determining an updated state estimate of a manned VTOL aerial vehicle, according to some embodiments;

FIG. 9 is a process flow diagram of a computer-implemented method for determining an updated state estimate of a manned VTOL aerial vehicle, according to some embodiments;

FIG. 10 is a process flow diagram of a computer-implemented method for determining a state estimate of a manned VTOL aerial vehicle, according to some embodiments;

FIG. 11 is a schematic diagram of a portion of a control system, according to some embodiments;

FIG. 12 is a schematic diagram of another portion of the control system of FIG. 11;

FIG. 13 is a schematic diagram of a portion of a control system, according to some embodiments; and

FIG. 14 is a schematic diagram of another portion of the control system of FIG. 13.

FIG. 15 is a schematic diagram of a portion of a control system, according to some embodiments;

FIG. 16 is a schematic diagram of a portion of a control system, according to some embodiments;

FIG. 17 is a block diagram of a propulsion system, according to some embodiments;

FIG. 18 is a schematic diagram of a portion of an alternate control system, according to some embodiments; and

FIG. 19 is a schematic diagram of another portion of the alternate control system of FIG. 18, according to some embodiments.

### DESCRIPTION OF EMBODIMENTS

Manned vertical take-off and landing (VTOL) aerial vehicles are used in a number of applications. For example, competitive manned VTOL aerial vehicle racing can involve a plurality of manned VTOL aerial vehicles navigating a track, each with a goal of navigating the track in the shortest amount of time. The track may have a complex shape, may cover a large area and/or may include a number of obstacles around which the manned VTOL aerial vehicles must navigate (including other vehicles), for example.

It is important to minimise the likelihood of manned VTOL aerial vehicles colliding, either with other vehicles or objects. For example, in the context of racing, it is important that the manned VTOL aerial vehicles do not collide with other vehicles in the race or objects associated with the track (e.g. the ground, walls, trees, unmanned autonomous aerial vehicles, birds etc.). Furthermore, the track may include virtual objects that are visible, for example, through a heads-up display (HUD), and avoiding these virtual objects is also important. Collision with an object can cause damage to the manned VTOL aerial vehicle, particularly when the manned VTOL aerial vehicle is traveling at a high speed. Furthermore, collisions can be dangerous to people or objects nearby that can be hit by debris or the manned VTOL aerial vehicle itself

A significant technical problem exists in providing a manned VTOL aerial vehicle that a pilot can navigate across a region (e.g. the track) whilst minimising the risk that the manned VTOL aerial vehicle crashes (e.g. due to pilot error, equipment failure etc.). Determining an accurate estimate of the manned VTOL aerial vehicle's state can assist with vehicle navigation to, for example, reduce the risk that the manned VTOL aerial vehicle collides with an object in the region, or unintentionally leaves the region.

The computer-implemented methods and systems of the embodiments may comprise technology and methods described in PCT Application No. PCT/AU2021/051533 filed 21 Dec. 2021 and titled “Collision avoidance for manned vertical take-off and landing aerial vehicles”, the contents of which are hereby incorporated by reference.

### Manned Vertical Take-Off and Landing Aerial Vehicle

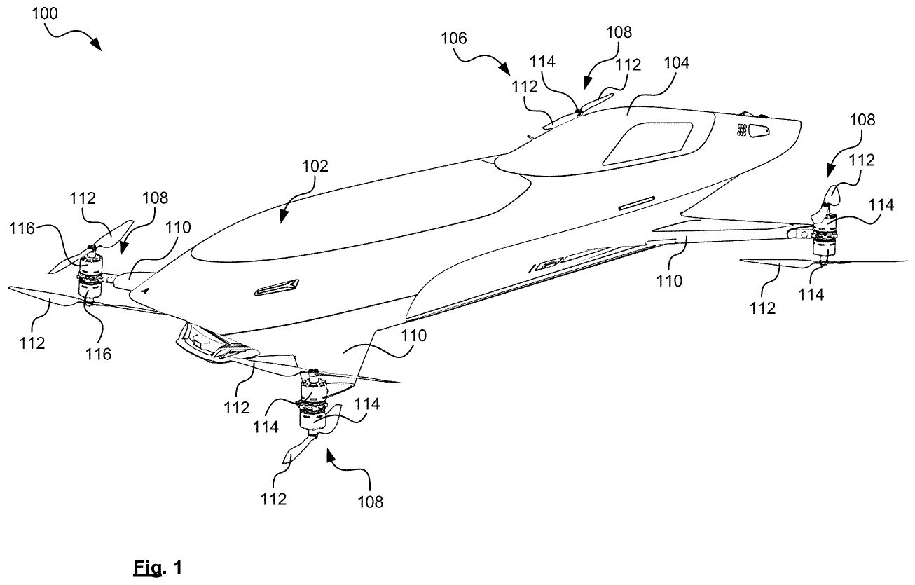

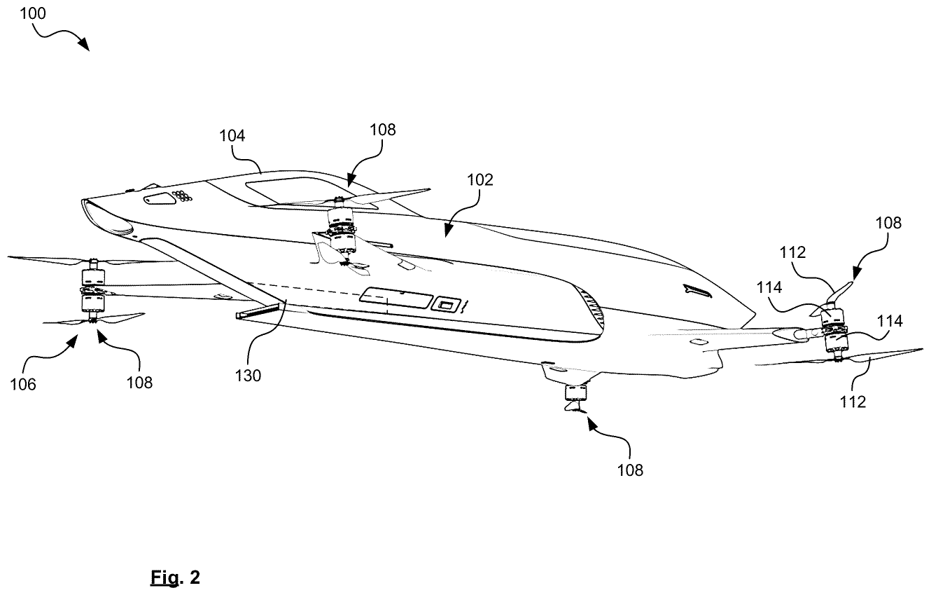

FIG. 1 illustrates a front perspective view of a manned vertical take-off and landing aerial vehicle 100. FIG. 2 illustrates a rear perspective view of the manned VTOL aerial vehicle 100. The manned VTOL aerial vehicle 100 is configured to move within a region. Specifically, the manned VTOL aerial vehicle 100 is configured to fly within a region that comprises an object 113. In some embodiments, the manned VTOL aerial vehicle 100 may be referred to as a speeder.

The manned VTOL aerial vehicle 100 is a rotary wing vehicle. The manned VTOL aerial vehicle 100 can move omnidirectionally in a three-dimensional space. In some embodiments, the manned VTOL aerial vehicle 100 has a constant deceleration limit.

The manned VTOL aerial vehicle 100 comprises a body 102. The body 102 may comprise a fuselage. The cockpit 104 comprises a display (not shown). The display is configured to display information to the pilot. The display may be implemented as a heads-up display, an electroluminescent (ELD) display, light-emitting diode (LED) display, quantum dot (QLED) display, organic light-emitting diode (OLED) display, liquid crystal display, a plasma screen, as a cathode ray screen device or the like.

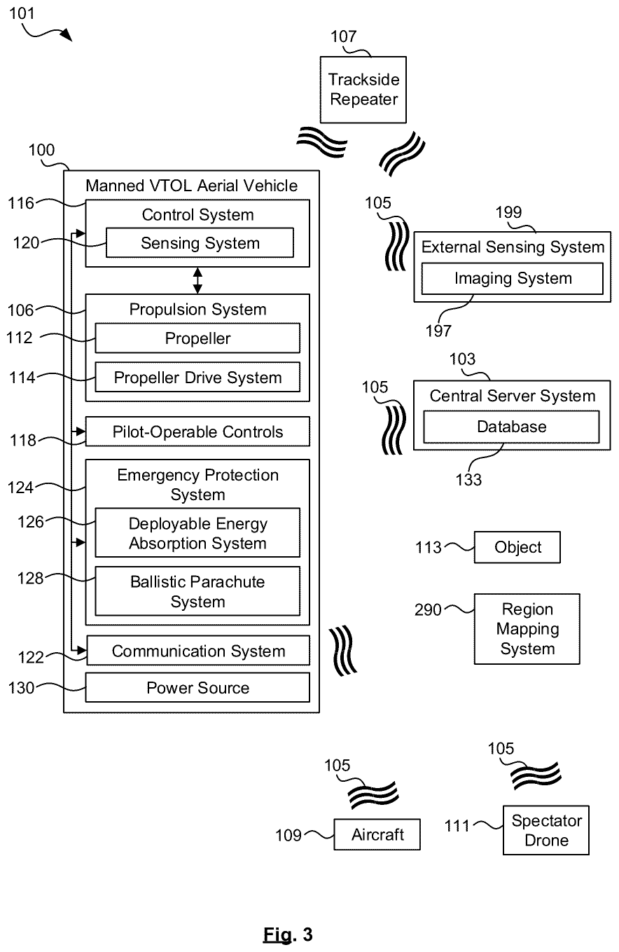

The body 102 comprises a cockpit 104 sized and configured to accommodate a human pilot. In some embodiments, the body 102 comprises, or is in the form of a monocoque. For example, the body 102 may comprise or be in the form of a carbon fibre monocoque. The manned VTOL aerial vehicle 100 comprises pilot-operable controls 118 (FIG. 3) that are accessible from the cockpit 104. The manned VTOL aerial vehicle 100 comprises a propulsion system 106. The propulsion system 106 is carried by the body 102 to propel the body 102 during flight.

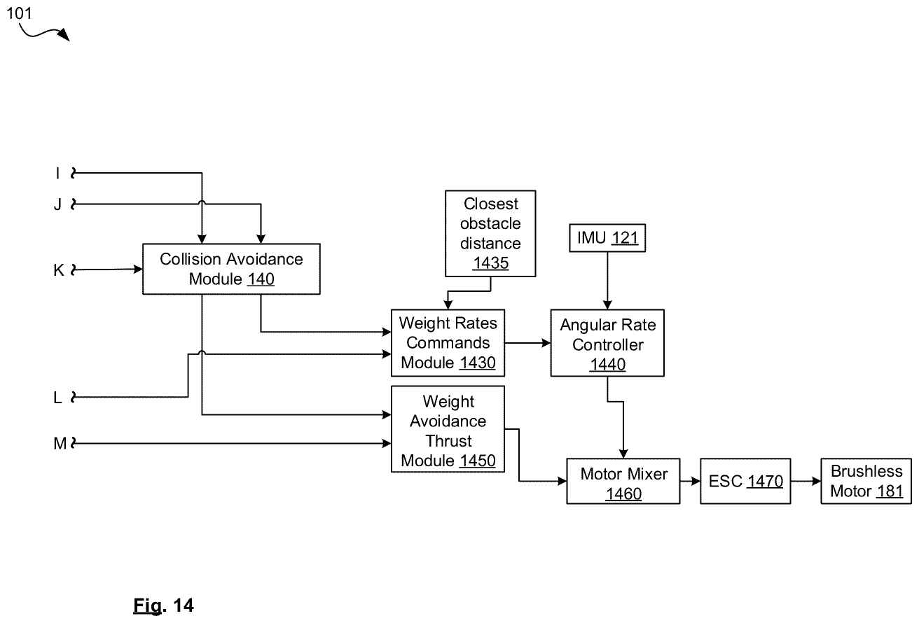

The propulsion system 106 comprises a propeller system 108. The propeller system 108 comprises a propeller 112 and a propeller drive system 114. The propeller system 108 comprises multiple propellers 112 and a propeller drive system 114 for each propeller 112. The propeller drive system 114 comprises a propeller motor. The propeller drive system 114 may comprise a brushless motor 181 (FIG. 14). In other words, the propeller drive system 114 may comprise a motor. The motor may be a brushless motor 181. The propeller motor may be controlled via an electronic speed control (ESC) circuit for each propeller 112 of the propeller system 108, as illustrated in FIG. 17.

The propulsion system 106 of the manned VTOL aerial vehicle 100 illustrated in FIG. 1 and FIG. 2 comprises a plurality of propeller systems 108. In particular, the propulsion system 106 of the manned VTOL aerial vehicle 100 illustrated in FIG. 1 and FIG. 2 comprises four propeller systems 108. Each propeller system 108 comprises a first propeller and a first propeller drive system. Each propeller system 108 also comprises a second propeller and a second propeller drive system. The first propeller drive system is configured to selectively rotate the first propeller in a first direction of rotation or a second direction opposite the first direction. The second propeller drive system is configured to selectively rotate the second propeller in the first direction of rotation or the second direction.

Each propeller system 108 is connected to a respective elongate body portion 110 of the body 102. The elongate body portions 110 may be referred to as “arms” of the body 102. Each propeller system 108 is mounted to the body 102 such that the propeller systems 108 form a generally quadrilateral profile.

By selective control of the propeller systems 108, the manned VTOL aerial vehicle 100 can be accurately controlled to move within three-dimensional space. The manned VTOL aerial vehicle 100 is capable of vertical take-off and landing.

### Aerial Vehicle System

FIG. 3 is a block diagram of an aerial vehicle system 101, according to some embodiments. The aerial vehicle system 101 comprises the manned VTOL aerial vehicle 100. As previously described, the manned VTOL aerial vehicle 100 comprises a propulsion system 106 that comprises a plurality of propellers 112 and propeller drive systems 114. The manned VTOL aerial vehicle 100 comprises a control system 116. The control system 116 is configured to communicate with the propulsion system 106. In particular, the control system 116 is configured to control the propulsion system 106 so that the propulsion system 106 can selectively propel the body 102 during flight.

The manned VTOL aerial vehicle 100 comprises a sensing system 120. In particular, the control system 116 comprises the sensing system 120. The sensing system 120 is configured to generate sensor data. The control system 116 is configured to process the sensor data to control the manned VTOL aerial vehicle 100.

The manned VTOL aerial vehicle 100 comprises pilot-operable controls 118. A pilot can use the pilot-operable controls 118 to control the manned VTOL aerial vehicle 100 in flight. The pilot-operable controls are configured to communicate with the control system 116. In particular, the control system 116 processes input data generated by actuation of the pilot-operable controls 118 by the pilot to control the manned VTOL aerial vehicle 100. The control system 116 is configured to process the input data generated by the actuation of the pilot-operable controls 118. In some embodiments, the input data is in the form of an input vector. The input data may be indicative of an intended control velocity of the manned VTOL aerial vehicle 100, as is described in more detail herein.

The manned VTOL aerial vehicle 100 comprises a communication system 122. The communication system 122 is configured to communicate with the control system 116. The manned VTOL aerial vehicle 100 is configured to communicate with other computing devices using the communication system 122. The communication system 122 may comprise a vehicle network interface 155. The vehicle network interface 155 is configured to enable the manned VTOL aerial vehicle 100 to communicate with other computing devices using one or more communications networks. The vehicle network interface 155 may comprise a combination of network interface hardware and network interface software suitable for establishing, maintaining and facilitating communication over a relevant communication channel. Examples of a suitable communications network include a cloud server network, wired or wireless internet connection, a wireless local area network (WLAN) such as Wi-Fi (IEEE 82.15.1) or Zigbee (IEE 802.15.4), a wireless wide area network (WWAN) such as cellular 4G LTE and 5G or another cellular network connection, low power wide area networks (LPWAN) such as SigFox and Lora, Bluetooth™ or other near field radio communication, and/or physical media such as a Universal Serial Bus (USB) connection.

The manned VTOL aerial vehicle 100 also comprises an internal communication network (not shown). The internal communication network is a wired network. The internal communication network connects the at least one processor 132, memory 134 and other components of the manned VTOL aerial vehicle 100 such as the propulsion system 106. The internal communication network may comprise a serial link, Ethernet network, a controlled area network (CAN) or another network.

The manned VTOL aerial vehicle 100 comprises an emergency protection system 124. The emergency protection system 124 is in communication with the control system 116. The emergency protection system 124 is configured to protect the pilot and/or the manned VTOL aerial vehicle 100 in a case where the manned VTOL aerial vehicle 100 is in a collision. That is, the control system 116 may deploy one or more aspects of the emergency protection system 124 to protect the pilot and/or the manned VTOL aerial vehicle 100.

The emergency protection system 124 comprises a deployable energy absorption system 126. In some embodiments, the deployable energy absorption system 126 comprises an airbag. The deployable energy absorption system 126 is configured to deploy in the case where the manned VTOL aerial vehicle 100 is in a collision. The deployable energy absorption system 126 may deploy if an acceleration of the manned VTOL aerial vehicle 100 exceeds an acceleration threshold. For example, the deployable energy absorption system 126 may deploy if the control system 116 senses or determines a deceleration magnitude of the manned VTOL aerial vehicle 100 that is indicative of a magnitude of a deceleration of the manned VTOL aerial vehicle 100 greater than a predetermined deceleration magnitude threshold.

The emergency protection system 124 comprises a ballistic parachute system 128. The ballistic parachute system 128 is configured to deploy to protect the pilot and/or the manned VTOL aerial vehicle 100 in a number of conditions. These may include the case where the manned VTOL aerial vehicle 100 is in a collision, or where the propulsion system 106 malfunctions. For example, if one or more of the propeller drive systems 114 fail and the manned VTOL aerial vehicle 100 is unable to be landed safely, the ballistic parachute system 128 may deploy to slow the descent of the manned VTOL aerial vehicle 100. In some cases, the ballistic parachute system 128 is configured to deploy if two propeller drive systems 114 on one elongate body portion 110 fail.

The manned VTOL aerial vehicle 100 comprises a power source 130. The power source 130 may comprise one or more batteries. For example, the manned VTOL aerial vehicle 100 may comprise one or more batteries that are stored in a lower portion of the body 102. For example, as shown in FIG. 2, the batteries may be stored below the cockpit 104. The power source 130 is configured to power each sub-system of the manned VTOL aerial vehicle 100 (e.g. the control system 116, propulsion system 106 etc.). The manned VTOL aerial vehicle 100 comprises a battery management system. The battery management system is configured to estimate a charge state of the one or more batteries. The battery management system is configured to perform battery balancing. The battery management system is configured to monitor the health of the one or more batteries. The battery management system is configured to monitor a temperature of the one or more batteries. The battery management system is configured to monitor a tension of the one or more batteries. The battery management system is configured to isolate a battery of the one or more batteries from a load, if required. The battery management system is configured to saturate an input power of the one or more batteries. The battery management system is configured to saturate an output power of the one or more batteries.

The aerial vehicle system 101 also comprises a central server system 103. The central server system 103 is configured to communicate with the manned VTOL aerial vehicle 100 via a communications network 105. The communications network 105 may be as previously described. The central server system 103 is configured to process vehicle data provided to the central server system 103 by the manned VTOL aerial vehicle 100. The central server system 103 is also configured to provide central server data to the manned VTOL aerial vehicle 100.

The central server system 103 may comprise a database 133. Alternatively, the central server system 103 may be in communication with the database 133 (e.g. via a network such as the communications network 105). The database 133 may therefore be a cloud-based database. The central server system 103 is configured to store the vehicle data in the database 133. The central server system 103 is configured to store the central server data in the database 133.

For example, the manned VTOL aerial vehicle 100 may be configured and/or operable to fly around a track. The track may be, or may form part of, the region described herein. The central server system 103 may be configured to communicate information regarding the track to the manned VTOL aerial vehicle 100.

The aerial vehicle system 101 may also comprise a trackside repeater 107. The trackside repeater 107 is configured to repeat wireless signals generated by the manned VTOL aerial vehicle 100 and/or the central server system 103 so that the manned VTOL aerial vehicle 100 and the central server system 103 can communicate at further distances than would be enabled without the trackside repeater 107. In some embodiments, the aerial vehicle system 100 comprises a plurality of trackside repeaters 107.

The aerial vehicle system 101 comprises an external sensing system 199. The external sensing system 199 is configured to generate external sensing system data. The external sensing system data may relate to one or more of the manned VTOL aerial vehicle 100 and the region within which the manned VTOL aerial vehicle 100 is located. The external sensing system 199 comprises an external sensing system imaging system 197. The external sensing system imaging system 197 is configured to generate external sensing system image data. For example, the external sensing system imaging system 197 may comprise one or more of an external LIDAR system configured to generate external LIDAR data, an external RADAR system configured to generate external RADAR data and an external visible spectrum imaging system configured to generate external visible spectrum image data.

The external sensing system 199 is configured to generate the external sensing system data based at least in part on inputs received by the external sensing system imaging system 197. For example, the external sensing system 199 is configured to generate point cloud data. This may be referred to as additional point cloud data, as it is additional to the point cloud data generated by the manned VTOL aerial vehicle 100 itself.

The external sensing system 199 is configured to provide the external sensing system data to the central server system 103 and/or the manned VTOL aerial vehicle 100 via the communications network 105 (and the trackside repeater 107 where necessary). The external sensing system 199 may comprise an external sensing system communication system (not shown). The external sensing system communication system may enable the external sensing system 199 to communicate with the central server system 103 and/or the manned VTOL aerial vehicle 100 (e.g. via the communications network 105), for example via one or more antennae of the external sensing system 199. Therefore, the external sensing system communication system may enable the external sensing system 199 to provide the external sensing system data to the central server system 103 and/or the manned VTOL aerial vehicle 100.

In some embodiments, the external sensing system 199 may be considered part of the central server system 103. In some embodiments, the central server system 103 may provide the external sensing system data to the manned VTOL aerial vehicle 100 (e.g. via the communications network 105).

In some embodiments, the at least one processor 132 is configured to receive the external LIDAR data, the external RADAR data and the external visible spectrum imaging data. The external LIDAR data may comprise an external region point cloud representing the region.

The aerial vehicle system 101 also comprises one or more other aircraft 109. The other aircraft 109 may be configured to communicate with the manned VTOL aerial vehicle 100 via the communications network 105 and/or the trackside repeater 107. For example, the aerial vehicle system 101 may also comprise a spectator drone 111. The spectator drone 111 may be configured to communicate with the manned VTOL aerial vehicle 100 via the communications network 105 and/or the trackside repeater 107.

In some embodiments, the spectator drone 111 is configured to generate additional image data. The additional image data may comprise additional three-dimensional data. For example, the spectator drone 111 may comprise a LIDAR system and/or another imaging system capable of generating the additional three-dimensional data. The additional three-dimensional data may be in the form of one or more of a point cloud (i.e. it may be point cloud data) and a depth map (i.e. it may be depth map data). In some embodiments, the additional image data comprises one or more of the additional three-dimensional data, additional visible spectrum image data, additional LIDAR data, additional RADAR data and additional infra-red image data. The spectator drone 111 is configured to provide the additional image data to the central server system 103. The spectator drone 111 may provide the additional image data directly to the central server system 103 using the communications network 105. Alternatively, the spectator drone 111 may provide the additional image data to the central server system 103 via one or more of the trackside repeaters 107. The central server system 103 is configured to store the additional image data in the database 133.

In some embodiments, the spectator drone 111 is configured to be a trackside repeater. Therefore, the manned VTOL aerial vehicle 100 may communicate with the central server system 103 via the spectator drone 111. As such, the spectator drone 111 may be considered to be a communications relay or a communications backup (e.g. if one of the trackside repeaters 107 fails).

The aerial vehicle system 101 comprises a region mapping system 290. The region mapping system 290 is configured to generate region mapping system data. The region mapping system 290 is configured to generate a three-dimensional model of the region, based on the region mapping system data. The region mapping system 290 may comprise one or more of a region mapping camera system configured to generate visible spectrum region data, a region mapping LIDAR system configured to generate LIDAR region data and a region mapping RADAR system configured to generate RADAR region data. The region mapping system data comprises one or more of the visible spectrum region data, the LIDAR region data and the RADAR region data.

The region mapping system 290 (e.g. at least one region mapping system processor) is configured to determine the three-dimensional model of the region based at least in part on the region mapping system data (e.g. the visible spectrum region data, the LIDAR region data and the RADAR region data). In some embodiments, the region mapping system 290 is configured to process the visible spectrum region data to generate a region depth map. In some embodiments, the region mapping system 290 is configured to process the LIDAR data to determine an initial region point cloud.

The region mapping system 290 generates a three-dimensional occupancy grid based at least in part on the region mapping system data. For example, the region mapping system 290 determines the three-dimensional occupancy grid based at least in part on the region depth map and/or the initial region point cloud. The three-dimensional occupancy grid comprises a plurality of voxels. Each voxel is associated with a voxel probability that is indicative of a probability that a corresponding point of the region comprises an object and/or surface.

The three-dimensional occupancy grid may be an Octomap. In some embodiments, the region mapping system 290 generates the three-dimensional occupancy grid as is described in “OctoMap: An efficient probabilistic 3D mapping framework based on octrees”, Hornung, Armin & Wurm, Kai & Bennewitz, Maren & Stachniss, Cyrill & Burgard, Wolfram, (2013), Autonomous Robots. 34. 10.1007/s10514-012-9321-0 the contents of which is incorporated by reference in its entirety.

The region mapping system 290 is configured to provide the three-dimensional model of the region to the manned VTOL aerial vehicle 100 and/or the central server system 103.

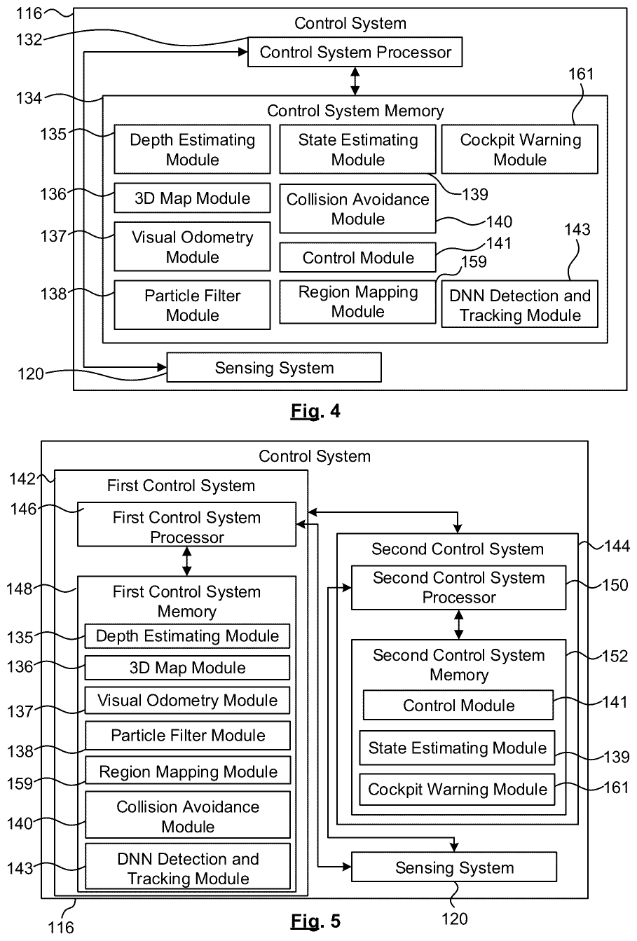

FIG. 4 is a block diagram of the control system 116, according to some embodiments. The control system 116 comprises at least one processor 132. The at least one processor 132 is configured to be in communication with memory 134. As previously described, the control system 116 comprises the sensing system 120. The sensing system 120 is configured to communicate with the at least one processor 132. In some embodiments, the sensing system 120 is configured to provide the sensor data to the at least one processor 132. In some embodiments, the at least one processor 132 is configured to receive the sensor data from the sensing system 120. In some embodiments, the at least one processor 132 is configured to retrieve the sensor data from the sensing system 120. The at least one processor 132 is configured to store the sensor data in the memory 134.

The at least one processor 132 is configured to execute program instructions stored in memory 134 to cause the control system 116 to function as described herein. In particular, the at least one processor 132 is configured to execute the program instructions to cause the manned VTOL aerial vehicle 100 to function as described herein. In other words, the program instructions are accessible by the at least one processor 132, and are configured to cause the at least one processor 132 to function as described herein. In some embodiments, the program instructions may be referred to as control system program instructions.

In some embodiments, the program instructions are in the form of program code. The at least one processor 132 comprises one or more microprocessors, central processing units (CPUs), application specific instruction set processors (ASIPs), application specific integrated circuits (ASICs), graphics processing units (GPUs), tensor processing units (TPUs), field-programmable gate arrays (FPGAs) or other processors capable of reading and executing program code. The program instructions comprise a depth estimating module 135, a three-dimensional map module 136, a visual odometry module 137, a particle filter module 138, a region mapping module 159, a state estimating module 139, a collision avoidance module 140, a cockpit warning module 161, a DNN detection and tracking module 143, and a control module 141.

Memory 134 may comprise one or more volatile or non-volatile memory types. For example, memory 134 may comprise one or more of random access memory (RAM), read-only memory (ROM), electrically erasable programmable read-only memory (EEPROM) or flash memory. Memory 134 is configured to store program code accessible by the at least one processor 132. The program code may comprise executable program code modules. In other words, memory 134 is configured to store executable code modules configured to be executable by the at least one processor 132. The executable code modules, when executed by the at least one processor 132 cause the at least one processor 132 to perform certain functionality, as described herein. In the illustrated embodiment, the depth estimating module 135, the three-dimensional map module 136, the visual odometry module 137, the particle filter module 138, region mapping module 159, the cockpit warning module 161, the state estimating module 139, the collision avoidance module 140, the DNN detection and tracking module 143, and the control module 141 are in the form of program code stored in the memory 134.

The depth estimating module 135, the three-dimensional map module 136, the visual odometry module 137, the particle filter module 138, the state estimating module 139, the region mapping module 159, the cockpit warming module 161, the collision avoidance module 140, the DNN detection and tracking module 143, and/or the control module 141 are to be understood to be one or more software programs. They may, for example, be represented by one or more functions in a programming language, such as C++, C, Python or Java. The resulting source code may compiled and stored as computer executable instructions on memory 134 that are in the form of the relevant executable code module.

Memory 134 is also configured to store a three-dimensional model. The three-dimensional model may be a three-dimensional model of the region. That is, the three-dimensional model may represent the region. The three-dimensional model may have an orientation that corresponds with that of the region, and surface of the three-dimensional model may correspond to surfaces of the region. One or more positions within the three-dimensional model may correspond to one or more positions within the region. Therefore, in some embodiments, the position estimate of the state estimate may be considered to be indicative of a position of the manned VTOL aerial vehicle within the three-dimensional model.

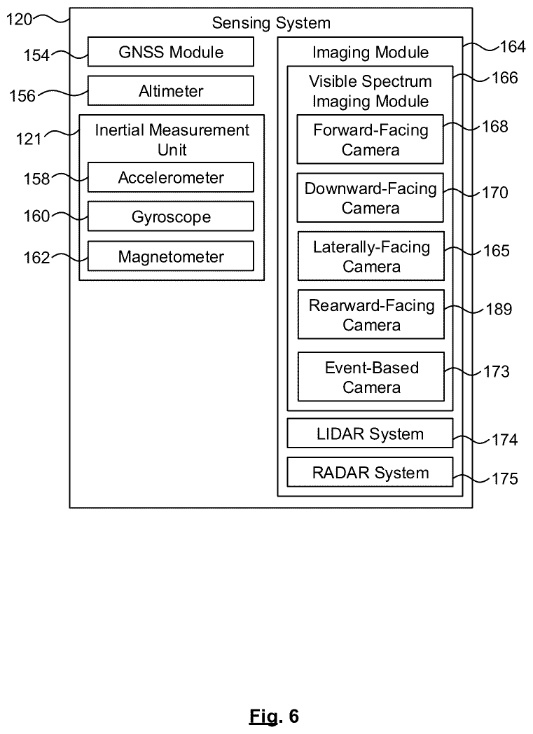

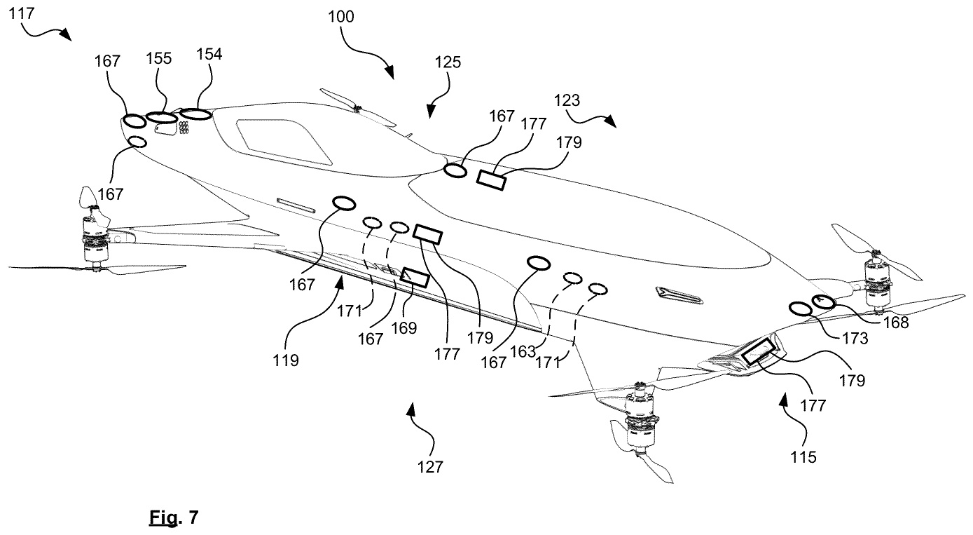

FIG. 6 is a block diagram of the sensing system 120, according to some embodiments. The sensing system 120 comprises a Global Navigation Satellite System (GNSS) module 154. The GNSS module 154 may comprise or be in the form of a GNSS real time kinetics (RTK) sensor. The GNSS module 154 may be configured to receive a Differential GNSS RTK correction signal from a fixed reference ground station. The reference ground station may be a GNSS reference ground station. This may be, for example, via the communications network 105, or another communications network.

The GNSS module 154 is configured to generate GNSS data. The GNSS data is indicative of one or more of a latitude, a longitude and an altitude of the manned VTOL aerial vehicle 100. The GNSS data may be in the form of a GNSS data vector that is indicative of the latitude, longitude and/or altitude of the manned VTOL aerial vehicle 100 at a particular point in time. Alternatively, the GNSS data may comprise GNSS time-series data. The GNSS time-series data can be indicative of the latitude, longitude and/or altitude of the manned VTOL aerial vehicle 100 over a time window. The GNSS time-series data can include GNSS data vectors that are sampled at a particular GNSS time frequency. The GNSS data may include a GNSS uncertainty metric that is indicative of an uncertainty of the relevant GNSS data.

The GNSS module 154 may be configured to utilise a plurality of GNSS constellations. For example, the GNSS module may be configured to utilise one or more of a Global Positioning System (GPS), a Global Navigation Satellite System (GLONASS), a BeiDou Navigation Satellite System (BDS), a Galileo system, a Quasi-Zenith Satellite System (QZSS) and an Indian Regional Navigation Satellite System (IRNSS or NavIC). In some embodiments, the GNSS module 154 is configured to utilise a plurality of GNSS frequencies simultaneously. In some embodiments, the GNSS module 154 is configured to utilise a plurality of GNSS constellations simultaneously.

The GNSS module 154 is configured to provide the GNSS data to the control system 116. In some embodiments, the GNSS module 154 is configured to provide the GNSS data to the at least one processor 132. The GNSS module 154 is configured to provide the GNSS data to the at least one processor 132. The sensor data comprises the GNSS data.

The sensing system 120 comprises an altimeter 156. The altimeter 156 is configured to generate altitude data. The altitude data is indicative of an altitude of the manned VTOL aerial vehicle 100. The altimeter 156 may comprise a barometer. The barometer may be configured to determine an altitude estimate above a reference altitude. The reference altitude may be an altitude threshold. The altimeter 156 may comprise a radar altimeter 163. The radar altimeter 163 is configured to determine an estimate of an above-ground altitude. That is, the radar altimeter 163 is configured to determine an estimate of a distance between the manned VTOL aerial vehicle 100 and the ground. The altimeter 156 is configured to provide the altitude data to the control system 116. In some embodiments, the altimeter 156 is configured to provide the altitude data to the at least one processor 132. The sensor data comprises the altitude data.

The sensing system 120 comprises an inertial measurement unit 121. The inertial measurement unit 121 comprises an accelerometer 158. The accelerometer 158 is configured to generate accelerometer data. The accelerometer data is indicative of an acceleration of the manned VTOL aerial vehicle 100. The accelerometer data is indicative of acceleration in one or more of a first acceleration direction, a second acceleration direction and a third acceleration direction. The first acceleration direction, second acceleration direction and third acceleration direction may be orthogonal with respect to each other. The accelerometer 158 is configured to provide the accelerometer data to the control system 116. In some embodiments, the accelerometer 158 is configured to provide the accelerometer data to the at least one processor 132. The sensor data comprises the accelerometer data.

The inertial measurement unit 121 comprises a gyroscope 160. The gyroscope 160 is configured to generate gyroscopic data. The gyroscopic data is indicative of an orientation of the manned VTOL aerial vehicle 100. The gyroscope 160 is configured to provide the gyroscopic data to the control system 116. In some embodiments, the gyroscope 160 is configured to provide the gyroscopic data to the at least one processor 132. The sensor data comprises the gyroscopic data.

The inertial measurement unit 121 comprises a magnetometer sensor 162. The magnetometer sensor 162 is configured to generate magnetic field data. The magnetic field data is indicative of an azimuth orientation of the manned VTOL aerial vehicle 100. The magnetometer sensor 162 is configured to provide the magnetic field data to the control system 116. In some embodiments, the magnetometer sensor 162 is configured to provide the magnetic field data to the at least one processor 132. The sensor data comprises the magnetic field data.

The sensing system comprises an imaging module 164. The imaging module 164 is configured to generate image data. In particular, the imaging module 164 is configured to generate image data that is associate with the region around the manned VTOL aerial vehicle 100. The imaging module 164 is configured to provide the image data to the control system 116. In some embodiments, the imaging module 164 is configured to provide the image data to the at least one processor 132. The sensor data comprises the image data.

The imaging module 164 comprises a visible spectrum imaging module 166. The visible spectrum imaging module 166 is configured to generate visible spectrum image data that is associated with the region around the manned VTOL aerial vehicle 100. The visible spectrum imaging module 166 is configured to provide the visible spectrum image data to the control system 116. In some embodiments, the visible spectrum imaging module 166 is configured to provide the visible spectrum image data to the at least one processor 132. The image data comprises the visible spectrum image data.

The visible spectrum imaging module 166 comprises a plurality of visible spectrum cameras 167. The visible spectrum cameras 167 are distributed across the body 102 of the manned VTOL aerial vehicle 100. The image data comprises visible spectrum image data. The image data comprises the optical flow data.

The visible spectrum imaging module 166 comprises a forward-facing camera 168. The forward-facing camera 168 is configured to generate image data that is associated with a portion of the region visible in front of a front portion 115 of the manned VTOL aerial vehicle 100. The forward-facing camera 168 is configured to be mounted to the manned VTOL aerial vehicle 100. In some embodiments, the visible spectrum imaging module 166 comprises a plurality of forward-facing cameras 168. Each forward-facing camera 168 may have different (but possibly overlapping) fields of view to capture images of different regions visible in front of the front portion 115 of the manned VTOL aerial vehicle 100.

The visible spectrum imaging module 166 also comprises a downward-facing camera 170. The downward-facing camera 170 is configured to generate image data that is associated with a portion of the region visible below the manned VTOL aerial vehicle 100. The downward-facing camera 170 is configured to be mounted to the manned VTOL aerial vehicle 100. In some embodiments, the visible spectrum imaging module 166 comprises a plurality of downward-facing cameras 170. Each downward-facing camera 170 may have different (but possibly overlapping) fields of view to capture images of different regions visible below the body 102 of the manned VTOL aerial vehicle 100. The downward-facing camera 170 may be referred to as a ground-facing camera.

The visible spectrum imaging module 166 comprises a laterally-facing camera 165. The laterally-facing camera 165 is configured to generate image data that is associated with a portion of the region visible to a side of the manned VTOL aerial vehicle 100. The laterally-facing camera 165 is configured to be mounted to the manned VTOL aerial vehicle 100. In some embodiments, the visible spectrum imaging module 116 may comprise a plurality of laterally-facing cameras 165. Each laterally-facing camera 165 may have different (but possibly overlapping) fields of view to capture images of different regions visible laterally of the body 102 of the manned VTOL aerial vehicle 100.

The visible spectrum imaging module 166 comprises a rearward-facing camera 189. The rearward-facing camera 189 is configured to generate image data that is associated with a portion of the region visible behind the manned VTOL aerial vehicle 100. The rearward-facing camera 189 is configured to be mounted to the manned VTOL aerial vehicle 100. In some embodiments, the visible spectrum imaging module 116 may comprise a plurality of rearward-facing cameras 189. Each rearward-facing camera 189 may have different (but possibly overlapping) fields of view to capture images of different regions visible behind the body 102 of the manned VTOL aerial vehicle 100.

The visible spectrum imaging module 166 comprises an event-based camera 173. The event-based camera 173 may be as described in “Event-based Vision: A Survey”, G. Gallego et al., (2020), IEEE Transactions on Pattern Analysis and Machine Intelligence, doi: 10.1109/TPAMI.2020.3008413, the contents of which is incorporated herein by reference in its entirety.

The at least one processor 132 may execute the described visual odometry using the event-based camera 173. The at least one processor 132 may execute visual odometry as described in “Real-time Visual-Inertial Odometry for Event Cameras using Keyframe-based Nonlinear Optimization”, Rebecq, Henri & Horstschaefer, Timo & Scaramuzza, Davide, (2017), 10.5244/C.31.16, the contents of which is incorporated herein by reference in its entirety.

The imaging module 164 comprises a Light Detection and Ranging (LIDAR) system 174. The LIDAR system 174 is configured to generate LIDAR data associated with at least a portion of the region around the manned VTOL aerial vehicle 100. The image data comprises the LIDAR data. The LIDAR system 174 comprises a LIDAR scanner 177. In particular, the LIDAR system 174 comprises a plurality of LIDAR scanners 177. The LIDAR scanners 177 may be distributed across the body 102 of the manned VTOL aerial vehicle 100. The LIDAR system 174 comprises a solid-state scanning LIDAR sensor 169. The LIDAR system 174 comprises a one-dimensional LIDAR sensor 171, such as a time-of-flight flash LIDAR sensor, for example. The one-dimensional LIDAR sensor 171 may be in the form of a non-scanning LIDAR sensor.

The imaging module 164 comprises a Radio Detecting and Ranging (RADAR) system 175. The RADAR system 175 is configured to generate RADAR data associated with at least a portion of the region around the manned VTOL aerial vehicle 100. The image data comprises the RADAR data. The RADAR system 175 comprises a RADAR sensor 179. In particular, the RADAR system 175 comprises a plurality of RADAR sensors 179. The RADAR system 175 comprises a radar altimeter 163. The RADAR sensor 179 may be distributed across the body 102 of the manned VTOL aerial vehicle 100.

The RADAR system 175 is configured to generate a range-doppler map. The range-doppler map may be indicative of a position and a speed of the object 113. The sensor data may comprise the range-doppler map.

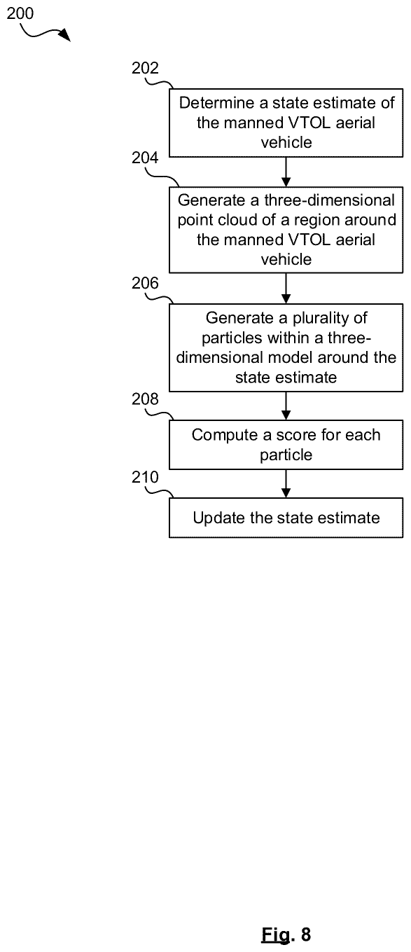

FIG. 7 is a perspective view of the manned VTOL aerial vehicle showing example positioning of a plurality of components of the sensing system 120, according to some embodiments. The manned VTOL aerial vehicle 100 comprises a front portion 115. The manned VTOL aerial vehicle 100 comprises a rear portion 117. The manned VTOL aerial vehicle 100 comprises a first lateral portion 119. The manned VTOL aerial vehicle 100 comprises a second lateral portion 123. The manned VTOL aerial vehicle 100 comprises an upper portion 125. The manned VTOL aerial vehicle 100 comprises a lower portion 127.

The rear portion 117 comprises a plurality of sensors. The sensors may be part of the sensing system 120. For example, as illustrated in FIG. 7, the rear portion 117 comprises a plurality of visible spectrum cameras 167. The rear portion 117 may comprise a rearward-facing camera (e.g. a rearward-facing visible spectrum camera). Alternatively, the rear portion 117 may comprise the downward-facing camera 170. The rear portion 117 comprises the network interface 155. The rear portion comprises the GNSS module 154.

The front portion 115 comprises a plurality of sensors. The sensors may be part of the sensing system 120. For example, as illustrated in FIG. 7, the front portion 115 comprises a visible spectrum camera 167. Specifically, the front portion 115 comprises the forward-facing camera 168. The front portion 115 comprises the event-based camera 173. In some embodiments, the event-based camera 173 comprises the forward-facing camera 168. The front portion 115 comprises a LIDAR scanner 177. The front portion 115 comprise a RADAR sensor 179.

The first lateral portion 119 may be a right-side portion of the manned VTOL aerial vehicle 100. The first lateral portion 119 comprises a visible spectrum camera 167. Specifically, first lateral portion 119 comprises a plurality of visible spectrum cameras 167. One or more of these may be the laterally facing camera 165 previously described. The first lateral portion 119 comprises a solid state scanning LIDAR sensor 169. The first lateral portion 119 comprises a LIDAR scanner 177. The first lateral portion 119 comprises a RADAR sensor 179.

The second lateral portion 123 may be a left-side portion of the manned VTOL aerial vehicle 100. The second lateral portion 123 may comprise the same or similar sensors as the first lateral portion 119.

The upper portion 125 comprises a plurality of sensors. The sensors may be part of the sensing system 120. The upper portion 125 comprises a visible spectrum camera 167. The upper portion 125 comprises a LIDAR scanner 177. The upper portion 125 comprises a RADAR sensor 179.

The lower portion 127 comprises a plurality of sensors. The sensors may be part of the sensing system 120. The lower portion comprises a visible spectrum camera 167. The visible spectrum camera 167 of the lower portion may assist with landing area monitoring and speed estimation using optical flow. The lower portion comprises the flash LIDAR sensor 171. The lower portion comprises a radar altimeter 163. The radar altimeter 163 may assist with vertical terrain monitoring. The lower portion comprises a one-dimensional LIDAR sensor (not shown). The one-dimensional LIDAR sensor may assist with landing the manned VTOL aerial vehicle 100. The lower portion 127 may also house the power source 130. For example, where the power source 130 comprises one or more batteries, the one or more batteries may be housed in the lower portion 127.

### Computer-Implemented Method 200 for Determining an Updated State Estimate of the Manned VTOL Aerial Vehicle

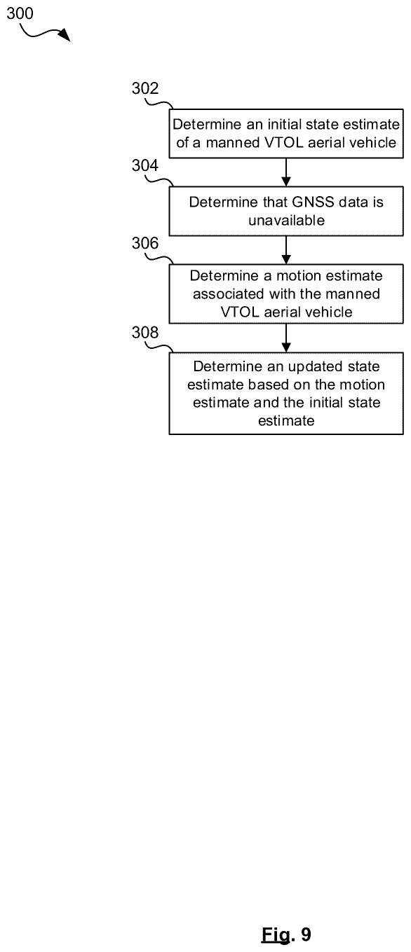

FIG. 8 is a process flow diagram illustrating a computer-implemented method 200 for determining an updated state estimate of the manned VTOL aerial vehicle 100, according to some embodiments. The computer-implemented method 200 is performed by the control system 116. In some embodiments, the computer-implemented method 200 is performed by the at least one processor 132.

FIG. 8 is to be understood as a blueprint for one or more software programs and may be implemented step-by-step, such that each step in FIG. 8 may, for example, be represented by a function in a programming language, such as C++, C, Python or Java. The resulting source code is then compiled and stored as computer executable instructions on memory 134.

At 202, the at least one processor 132 determines a state estimate of the manned VTOL aerial vehicle 100. The state estimate is indicative of a state of the manned VTOL aerial vehicle 100 within a region around the manned VTOL aerial vehicle 100. The state estimate is indicative of the state of the manned VTOL aerial vehicle 100 at a particular time. In some embodiments, the state of the manned VTOL aerial vehicle 100 may be indicative of a position of the manned VTOL aerial vehicle 100, an attitude of the manned VTOL aerial vehicle 100 and a velocity of the manned VTOL aerial vehicle 100.

The state of the manned VTOL aerial vehicle 100 may be indicative of a position of the manned VTOL aerial vehicle 100 within the region. The state estimate comprises a position estimate. The position estimate is indicative of the position of the manned VTOL aerial vehicle 100 within the region. The position estimate may comprise coordinates that are indicative of a three-dimensional position of the manned VTOL aerial vehicle 100 within the region (e.g. with respect to a fixed reference frame of the region).

The state of the manned VTOL aerial vehicle 100 may be indicative of a velocity of the manned VTOL aerial vehicle 100. The state estimate comprises a speed vector. The speed vector is indicative of the velocity of the manned VTOL aerial vehicle 100. The velocity may comprise a velocity magnitude and a velocity direction. The velocity direction may comprise coordinates that are indicative of a direction in which the manned VTOL aerial vehicle is travelling. The velocity magnitude may be referred to as a speed.

The state of the manned VTOL aerial vehicle 100 may be indicative of an attitude of the manned VTOL aerial vehicle 100. The state estimate comprises an attitude vector. The attitude vector is indicative of the attitude of the manned VTOL aerial vehicle 100.

The at least one processor 132 determines the position estimate that is indicative of the position of the manned VTOL aerial vehicle 100. In some embodiments, the at least one processor 132 determines the position estimate based at least in part on the GNSS data. The at least one processor 132 may receive the GNSS data from the GNSS module 154. In other words, the at least one processor 132 may determine the GNSS data. The GNSS data may be indicative of a latitude, a longitude and/or an altitude of the manned VTOL aerial vehicle 100. The position estimate may therefore comprise reference to, or be indicative of one or more of the latitude, longitude and altitude. Thus, the at least one processor 132 determines the state estimate based at least in part on the GNSS data.

In some embodiments, the at least one processor 132 determines the position estimate based at least in part on one or more of the LIDAR data, the visible spectrum image data and the RADAR data. Thus, the at least one processor 132 may determine the state estimate based at least in part on one or more of the LIDAR data, the visible spectrum image data and the RADAR data.

The at least one processor 132 determines the speed vector that is indicative of a velocity of the manned VTOL aerial vehicle 100. The at least one processor 132 may determine the speed vector based at least in part on one or more of the accelerometer data, the gyroscopic data, the magnetic field data and the image data that is associated with the region. In other words, the at least one processor 132 may determine the state estimate based at least in part on one or more of the altitude data, the accelerometer data, the gyroscopic data, the magnetic field data and the image data.

In some embodiments, the at least one processor 132 determines the speed vector based at least in part on one or more of the LIDAR data, the visible spectrum image data and the RADAR data. Thus, the at least one processor 132 may determine the state estimate based at least in part on one or more of the LIDAR data, the visible spectrum image data and the RADAR data. In other words, the at least one processor 132 may determine the speed vector based at least in part on the image data.

The at least one processor 132 determines the attitude vector that is indicative of the attitude of the manned VTOL aerial vehicle 100. In some embodiments, the at least one processor 132 determines the attitude vector based at least in part on one or more of the gyroscopic data, the accelerometer data and the magnetic field data. Thus, the at least one processor 132 may determine the state estimate based at least in part on one or more of the gyroscopic data, the accelerometer data and the magnetic field data.

In some embodiments, the at least one processor 132 determines the attitude vector based at least in part on one or more of the LIDAR data, the visible spectrum image data and the RADAR data. Thus, the at least one processor 132 may determine the state estimate based at least in part on one or more of the LIDAR data, the visible spectrum image data and the RADAR data. In other words, the at least one processor 132 may determine the attitude vector based at least in part on the image data.

In some embodiments, the at least one processor 132 determines the state estimate using visual odometry. The state estimate is a complementary position estimate, attitude estimate and/or velocity estimate. The at least one processor 132 determines a longitudinal velocity estimate that is indicative of a longitudinal velocity of the manned VTOL aerial vehicle 100. The longitudinal velocity estimate comprises a first longitudinal velocity component (V_{y}) and a second longitudinal velocity component (V_{y}). The at least one processor 132 determines the longitudinal velocity estimate based at least in part on the image data captured by the ground-facing camera 170. The at least one processor 132 determines an acceleration estimate that is indicative of an acceleration of the manned VTOL aerial vehicle 100, based at least in part on the accelerometer data provided by the accelerometer 158. The at least one processor 132 determines an orientation estimate that is indicative of an orientation of the manned VTOL aerial vehicle 100, based at least in part on the gyroscopic data provided by the gyroscope 160. The at least one processor 132 determines an altitude estimate that is indicative of an altitude of the manned VTOL aerial vehicle 100, based at least in part on the altitude data provided by the altimeter 156. The at least one processor 132 determines an azimuth orientation estimate of the manned VTOL aerial vehicle 100, based at least in part on the magnetic field data provided by the magnetometer sensor 162. The at least one processor 132 determines the state estimate based at least in part on the longitudinal velocity estimate. The at least one processor 132 determines the state estimate based at least in part on one or more of the acceleration estimate, the orientation estimate, the azimuth orientation estimate and optionally also the altitude estimate. In some embodiments, the at least one processor 132 determines the position estimate based at least in part on the longitudinal velocity estimate. In some embodiments, the at least one processor 132 determines the speed vector based at least in part on the longitudinal velocity estimate.

In some embodiments, the at least one processor 132 determines the position estimate and/or the velocity estimate using optical flow calculations as is described in “An open source and open hardware embedded metric optical flow CMOS camera for indoor and outdoor applications”, Honegger, Dominik & Meier, Lorenz & Tanskanen, Petri & Pollefeys, Marc, (2013), Proceedings—IEEE International Conference on Robotics and Automation. 1736-1741. 10.1109/ICRA.2013.6630805, the contents of which is incorporated by reference in its entirety.

In some embodiments, the at least one processor 132 determines the state estimate based at least in part on an egomotion estimate. The egomotion estimate comprises an estimated translation vector. The estimated translation vector is indicative of an estimated translation of the manned VTOL aerial vehicle 100 between a first time and a second time. The egomotion estimate comprises a rotation matrix. The rotation matrix is indicative of a rotation of the manned VTOL aerial vehicle 100 between the first time and the second time. The at least one processor 132 may execute the visual odometry module 137 to determine the egomotion estimate.

The first time may be referred to as an initial time. Time (e.g. the first time or the second time disclosed herein), when used in this disclosure, may correspond to a time, when measured using a reference clock (e.g. Greenwich Mean Time). That is, the time may correspond to a point in time. Alternatively, the time may be a reference time indicated by a time stamp. For example, the sensor data at a particular point in time may comprise, or be appended with a time stamp associated with the particular point in time. The time may correspond to the time stamp of the relevant sensor data. Alternatively, the time may correspond to a point defined by the time stamp. The time stamp may correspond to a reference time measured using a reference clock (e.g. Greenwich Mean Time). Alternatively, the time stamp may correspond to an internal time. For example, the time stamp may correspond to a count maintained by the at least one processor 132.

The at least one processor 132 determines the egomotion estimate based at least in part on image data captured by the forward-facing camera 168 mounted on the manned VTOL aerial vehicle 100. The at least one processor 132 determines an acceleration estimate that is indicative of an acceleration of the manned VTOL aerial vehicle 100, based at least in part on the accelerometer data provided by the accelerometer 158. The at least one processor 132 determines an orientation estimate that is indicative of an orientation of the manned VTOL aerial vehicle 100, based at least in part on the gyroscopic data provided by the gyroscope 160. The at least one processor 132 determines altitude data that is indicative of the altitude of the manned VTOL aerial vehicle 100, based at least in part on the altitude data provided by the altimeter 156. The at least one processor 132 determines an azimuth orientation estimate of the manned VTOL aerial vehicle 100, based at least in part on the magnetic field data provided by the magnetometer sensor 162. The at least one processor 132 determines the state estimate based at least in part on one or more of the egomotion estimate, the acceleration estimate, the orientation estimate, the altitude estimate and the azimuth orientation estimate. In some embodiments, the first state estimation may rely on an extended Kalman filter, separate from the extended Kalman filter used for the third state estimation.

The at least one processor 132 determines a state estimate confidence metric. The state estimate confidence metric is indicative of an error associated with the state estimate. The state estimate confidence metric may be referred to as a vehicle state estimate confidence metric. The at least one processor 132 determines the state estimate confidence metric based at least in part on an error associated with the sensor data used to determine the state estimate (e.g. the visible spectrum image data, LIDAR data etc.). In some embodiments, the state estimate confidence metric is indicative of a degree of error associated with the state estimate. In some embodiments, the state estimate comprises the state estimate confidence metric.

For example, the at least one processor 132 may determine the state estimate confidence metric based at least in part on an error associated with one or more of the GNSS data, the altitude data, the accelerometer data, the gyroscopic data, the magnetic field data, the visible spectrum image data, the optical flow data, the LIDAR data and the RADAR data. In some embodiments, the error is associated with the respective hardware component configured to generate the sensor data. For example, the at least one processor 132 may determine the state estimate confidence metric based at least in part on an error associated with the GNSS module 154, the altimeter 156, the inertial measurement unit 121, the accelerometer 158, the gyroscope 160, the magnetometer 162, the imaging module 164, the forward-facing camera 168, the downward-facing camera 170, the laterally-facing camera 165, the event-based camera 173, the optical flow camera 172, the LIDAR system 174 and the RADAR system 175.

In some embodiments, the method 200 further comprises receiving the external sensing system data generated by the external sensing system 199. The external sensing system data may comprise the state estimate and the state estimate confidence metric. The at least one processor 132 may determine the state estimate and the state estimate confidence metric by receiving the external sensing system data.

In some embodiments, the at least one processor 132 may determine the state estimate and the state estimate confidence metric based at least in part on the external sensing system data. The external sensing system data may comprise external sensing system image data, as previously described. The at least one processor 132 may determine the state estimate and the state estimate confidence metric based at least in part on the external sensing system image data, for example, as is described herein with reference to the visible spectrum image data.

In some embodiments, the external sensing system data comprises the three-dimensional model. That is, the at least one processor 132 may receive the three-dimensional model from another computing device, such as one forming part of the external sensing system 199. The at least one processor 132 may store the received three-dimensional model in the memory 134.

At 204, the at least one processor 132 generates a three-dimensional point cloud of the region. In other words, the at least one processor 132 generates a three-dimensional point cloud representing the region. The at least one processor 132 may generate the three-dimensional point cloud based on one or more of the LIDAR data, RADAR data, and visible spectrum image data, for example.

In some embodiments, the at least one processor 132 generates a depth map. The depth map is associated with the region. The at least one processor 132 generates the depth map based at least in part on the visible spectrum image data. In some embodiments, the at least one processor 132 generates the depth map using a deep neural network (DNN). The visible spectrum image data may be an input of the DNN.

The at least one processor 132 executes the depth estimating module 135 to generate the depth map. The depth estimating module 135 may be in the form of a DNN trained to recognise depth.

The at least one processor 132 generates the three-dimensional point cloud based at least in part on the depth map and the LIDAR data.

The LIDAR data may comprise a plurality of LIDAR points. Each LIDAR point is associated with three-dimensional LIDAR point coordinates and a LIDAR point intensity. The intensity may be proportional to a LIDAR point probability. Each intensity is indicative of a probability that the respective LIDAR point exists on a surface of the region or a surface of an object within the region. The LIDAR points may be filtered based at least in part on their intensity. The at least one processor 132 may filter the LIDAR points by excluding LIDAR points with a LIDAR point intensity that is below a LIDAR intensity threshold from further processing. The at least one processor 132 may discard these LIDAR points from the LIDAR data.

Outlier points of the depth map and/or the LIDAR data are excluded from the three-dimensional point cloud. In some embodiments, the three-dimensional point cloud may be referred to as a region point cloud. The region point cloud may therefore be associated with or represent the region.

The three-dimensional point cloud comprises a plurality of points. One or more of the points is represented by point data in the form of point data elements. The point data elements may represent coordinates in a spherical coordinate system. That is, in some embodiments, each point is represented by point data elements that correspond to a radius, an azimuth and a polar angle. The radius is indicative of the distance of the point from the manned VTOL aerial vehicle 100. The azimuth is indicative of a first angle at which the point is disposed, with respect to the manned VTOL aerial vehicle 100. The polar angle is indicative of a second angle at which the point is disposed with respect to the manned VTOL aerial vehicle 100. The first angle and the second angle may be measured with respect to axes that are perpendicular.

In some embodiments, the point data elements may represent coordinates in a Cartesian coordinate system. That is, each point data element may be indicative of a magnitude of a displacement of the point from the manned VTOL aerial vehicle in a particular axis of three-dimensional space.

In some embodiments, each point is associated with an intensity. The intensity may be a value, for example, between 0 and 1. The intensity may be proportional to a point probability. Each intensity is indicative of a probability that the respective point exists on a surface of the region or a surface of an object within the region. The point data elements of a point of the three-dimensional point cloud may therefore comprise an intensity value. Therefore, the points may be filtered based at least in part on their intensity. The at least one processor 132 may filter the points by excluding points with an intensity that is below an intensity threshold from further processing. The at least one processor 132 may discard these points from the three-dimensional point cloud.

The at least one processor 132 executes the three-dimensional map module 136 to generate the three-dimensional point cloud.

As previously described, the state estimate is indicative of a state of the manned VTOL aerial vehicle 100. As the three-dimensional model corresponds to the region around the manned VTOL aerial vehicle 100, the state estimate is also indicative of a state of the manned VTOL aerial vehicle within the three-dimensional model.

At 206, the at least one processor 132 generates a plurality of virtual particles within the three-dimensional model. In particular, the at least one processor 132 generates the plurality of particles within the three-dimensional model, around the state estimate. Each of the virtual particles represents a possible state of the manned VTOL aerial vehicle 100 within the three-dimensional model, and therefore within the region.

Each virtual particle is associated with a particle position. The particle position is indicative of the position of that particle within the three-dimensional model. The particle position corresponds to a theoretical position of the manned VTOL aerial vehicle 100 when disposed on that particle. Each virtual particle is also associated with a particle attitude. The particle attitude is indicative of the attitude of that particle within the three-dimensional model. The particle attitude corresponds to a theoretical attitude of the manned VTOL aerial vehicle 100 when disposed on that particle.

The at least one processor 132 generates the virtual particles such that a distance between adjacent particle positions is equal.

The at least one processor 132 executes the particle filter module 138 to generate the virtual particles.

At 208, the at least one processor computes a score for each virtual particle. In other words, the at least one processor computes a plurality of scores, each score being associated with one of the plurality of virtual particles. Each score is indicative of a difference between the three-dimensional model and the three-dimensional point cloud when the three-dimensional point cloud is centred on the respective virtual particle.

The three-dimensional point cloud may be translated such that an orientation direction of the three-dimensional point cloud corresponds to the orientation of the manned VTOL aerial vehicle 100, when disposed at the particle position at the particle attitude. That is, the three-dimensional point cloud may represent a portion of the region visible to the manned VTOL aerial vehicle 100, when the manned VTOL aerial vehicle state corresponds to the respective virtual particle (i.e. the position estimate and attitude estimate of the state estimate correspond to the particle position and the particle attitude respectively).

Computing one of the plurality of scores comprises determining a comparison metric for each point of the three-dimensional point cloud, when the three-dimensional point cloud is disposed on the relevant virtual particle. It will be understood that the three-dimensional point cloud being disposed on the relevant virtual particle means that the orientation direction of the three-dimensional point cloud is such that the three-dimensional point cloud represents the portion of the region visible to the manned VTOL aerial vehicle 100, if the state estimate of the manned VTOL aerial vehicle 100 corresponds to the respective virtual particle. The comparison metric is indicative of a distance between the respective point of the three-dimensional point cloud and a comparison point of the three-dimensional model.

The at least one processor 132 determines the comparison metric for a point of the three-dimensional point cloud by projecting a ray from the respective particle position to, and through the point of the three-dimensional point cloud. The at least one processor 132 determines a distance between the point of the three-dimensional point cloud and a point of the three-dimensional model that is intersected by the ray. The magnitude of the distance corresponds to the comparison metric of that point of the three-dimensional point cloud, for the respective virtual particle.

The at least one processor 132 computes a comparison metric for each of the points of the three-dimensional point cloud when the three-dimensional point cloud is disposed on a respective virtual particle. The at least one processor 132 computes the score for that virtual particle by summing the comparison metrics of each of the points of the three-dimensional point cloud when the three-dimensional point cloud is centred on that virtual particle.

The at least one processor 132 repeats this for each virtual particle. That is, the at least one processor 132 centres the three-dimensional point cloud on each of the virtual particles and determines a score for each of the virtual particles as is described above.

In some embodiments, a weight is associated with each virtual particle. The weight may be related to a particle confidence metric associated with the respective virtual particle. The weight may correspond to the score of that virtual particle.

The at least one processor 132 executes the particle filter module 138 to determine the score for each virtual particle.

At 210, the at least one processor 132 updates the state estimate. The at least one processor 132 determines a minimised virtual particle. The minimised virtual particle is one of the plurality of virtual particles. The score associated with the minimised virtual particle is lower than the scores associated with the other virtual particles of the plurality of virtual particles. That is, the minimised virtual particle is the virtual particle with the lowest sore. The at least one processor 132 sets the state estimate to correspond to the minimised virtual particle. Thus, the at least one processor 132 determines an updated state estimate.

The at least one processor 132 executes the collision avoidance module 140 to determine the updated state estimate.

In some embodiments, the at least one processor 132 determines an object state estimate. The object state estimate is indicative of a position of the object 113. The at least one processor 132 determines the object state estimate based at least in part on the sensor data. The object state estimate is indicative of a velocity of the object 113. The object state estimate is indicative of an attitude of the object 113. The object state estimate comprises an object position estimate. The object position estimate is indicative of the position of the object 113 within the region. The object state estimate comprises an object speed vector. The object speed vector is indicative of the velocity of the object 113. The velocity of the object 113 may comprise an object velocity magnitude and an object velocity direction. The object velocity magnitude may be referred to as an object speed. The object state estimate comprises an object attitude vector. The object attitude vector is indicative of an attitude of the object 113. The at least one processor 132 determines the object state estimate using the three dimensional point cloud. Alternatively, the at least one processor 132 receives the object state estimate from another computing device (e.g. the central server system 103). In some embodiments, the external sensing system data comprises the object state estimate.

The object 113 may be a static object. That is, the object 113 may be static with respect to the region (or a fixed reference frame of the region). Further, the object 113 may be static with respect to a fixed reference frame of the repulsion potential field model. The object 113 may be a dynamic object. That is, the object 113 may be dynamic (or move) with respect to the region (or the fixed reference frame of the region) over time. Alternatively, the object 113 may be dynamic with respect to a fixed reference frame of the repulsion potential field model.

The object 113 may be a real object. That is, the object 113 may exist within the three-dimensional space of the region. For example, the object 113 may define a surface (such as the ground, a wall, a ceiling etc.) or an obstacle (such as another vehicle, a track marker, a tree or a bird). Alternatively, the object 113 may be a virtual object. For example, the object 113 may be defined only in the repulsive field model. For example, the object 113 may be a virtual surface (such as a virtual wall, a virtual ceiling etc.) or a virtual obstacle (such as a virtual vehicle, a virtual track marker, a virtual tree or a virtual bird).

Virtual objects can be useful for artificially constraining the region within which the manned VTOL aerial vehicle can fly. For example, the virtual object can be in the form of a three-dimensional virtual boundary. The manned VTOL aerial vehicle 100 may be authorised to fly within the three-dimensional virtual boundary (e.g. a race track), and unauthorised to fly outside the three-dimensional virtual boundary. The three-dimensional virtual boundary can form a complex three-dimensional flight path, allowing simulation of a technically challenging flight path. Thus, the virtual objects can be used for geofencing. Virtual objects can also be used for pilot training. For example, when the pilot trains to race the manned VTOL aerial vehicle 100, other vehicles against which the pilot can race can be simulated using virtual objects. This reduces the need to actually have other vehicles present, and improves the safety of the pilot, as the risk of the pilot crashing is reduced.

The at least one processor 132 determines an object state estimate confidence metric. The object state estimate confidence metric is indicative of an error associated with the object state estimate. The at least one processor 132 determines the object state estimate confidence metric based at least in part on an error associated with the sensor data used to determine the object state estimate (e.g. the visible spectrum image data). In some embodiments, the object state estimate confidence metric is indicative of a degree of error associated with the object state estimate. In some embodiments, the object state estimate comprises the object state estimate confidence metric.

The at least one processor 132 executes DNN detection and tracking module 143 to determine the object state estimate based at least in part on the visible spectrum image data. The visible spectrum image data is used as an input to a Deep Neural Network. The at least one processor 132 detects, localises and/or classifies the object 113 based at least in part on the visible spectrum image data.

The at least one processor 132 may perform image segmentation to detect, localise and/or classify the object 113. The image segmentation may be based on a pixel value threshold, edge detection, clustering or a convolutional neural network (CNN), for example.

The at least one processor 132 may use an artificial neural network (ANN) to detect, localise and/or classify the object 113. The ANN may be in the form of a CNN-based architecture that may include one or more of an input layer, convolutional layers, fully connected layers, pooling layers, binary step activation functions, linear activation functions and non-linear activation functions.

For example, the at least one processor 132 may use a neural network to detect, localise and/or classify the object 113 as described in “Detection of a Moving UAV Based on Deep Learning-Based Distance Estimation”, Lai, Ying-Chih & Huang, Zong-Ying, (2020), Remote Sensing, 12(18), 3035, the contents of which is incorporated herein by reference in its entirety.

In some embodiments, the region comprises a plurality of objects 113. A first sub-set of the plurality of objects 113 may be dynamic objects. A second sub-set of the plurality of objects may be static objects.

Each object 113 is associated with a respective repulsion potential field function. The at least one processor 132 may generate the repulsion potential field model by summing the repulsion potential field functions.

In some embodiments, the at least one processor 132 determines the repulsion potential field model as is described in “Autonomous Collision Avoidance for a Teleoperated UAV Based on a Super-Ellipsoidal Potential Function”, Qasim, Mohammed Salim, (2016), University of Denver Electronic Theses and Dissertations, the contents of which is incorporated herein by reference in its entirety. For example, the at least one processor 132 determines the repulsion potential field model using the potential function described in the above document.

In some embodiments, the at least one processor 132 determines the repulsion potential field model as is described in U.S. Pat. No. 5,006,988A, the contents of which is incorporated herein by reference in its entirety.

The at least one processor 132 executes the region mapping module 159 to determine the object state estimate.

The at least one processor 132 may control the propulsion system 106 of the manned VTOL aerial vehicle 100 to avoid the object 113 (or the plurality of objects 113, where relevant). In particular, the at least one processor 132 may control the propulsion system 106 of the manned VTOL aerial vehicle 100 to avoid the object 113 based at least in part on the updated state estimate. The at least one processor 132 controls the propeller drive systems 114 to rotate the propellers as necessary to control the manned VTOL aerial vehicle in accordance with a control vector. The at least one processor 132 determines the control vector based at least in part on the updated state estimate. In some embodiments, the at least one processor 132 controls the propulsion system 106 of the manned VTOL aerial vehicle 100 such that the manned VTOL aerial vehicle 100 avoids colliding with the object, based at least in part on the updated state estimate and the object state estimate.

The at least one processor 132 executes the control module 141 to control the propulsion system 106 of the manned VTOL aerial vehicle 100 to avoid the object 113.

### Computer-Implemented Method 300 for Determining an Updated State Estimate of the Manned VTOL Aerial Vehicle

FIG. 9 is a process flow diagram illustrating a computer-implemented method 300 for determining an updated state estimate of the manned VTOL aerial vehicle 100. The computer-implemented method 300 is performed by the control system 116. In some embodiments, the computer-implemented method 300 is performed by the at least one processor 132.

FIG. 9 is to be understood as a blueprint for one or more software programs and may be implemented step-by-step, such that each step in FIG. 9 may, for example, be represented by a function in a programming language, such as C++, C, Python or Java. The resulting source code is then compiled and stored as computer executable instructions on memory 134.

At 302, the at least one processor 132 determines an initial state estimate of the manned VTOL aerial vehicle 100. The initial state estimate may be a state estimate as described previously. That is, the at least one processor 132 may determine the initial state estimate based at least in part on the sensor data. This may be, for example, as described herein with reference to the state estimate.

The initial state estimate comprises an initial position estimate. The initial position estimate is indicative of the position of the manned VTOL aerial vehicle 100 within the region. In particular, the initial position estimate is indicative of the position of the manned VTOL aerial vehicle 100 within the region at a first time. The initial position estimate may comprise coordinates that are indicative of a three-dimensional position of the manned VTOL aerial vehicle 100 within the region (e.g. with respect to a fixed reference frame of the region).

The first time may be referred to as an initial time. Time (e.g. the first time or the second time disclosed herein), when used in this disclosure, may correspond to a time, when measured using a reference clock (e.g. Greenwich Mean Time). That is, the time may correspond to a point in time. Alternatively, the time may be a reference time indicated by a time stamp. For example, the sensor data at a particular point in time may comprise, or be appended with a time stamp associated with the particular point in time. The time may correspond to the time stamp of the relevant sensor data. Alternatively, the time may correspond to a point defined by the time stamp. The time stamp may correspond to a reference time measured using a reference clock (e.g. Greenwich Mean Time). Alternatively, the time stamp may correspond to an internal time. For example, the time stamp may correspond to a count maintained by the at least one processor 132.

The initial state estimate comprises an initial speed vector. The initial speed vector is indicative of the velocity of the manned VTOL aerial vehicle 100. In particular, the initial speed vector is indicative of the velocity of the manned VTOL aerial vehicle 100 at the first time. The initial velocity may comprise an initial velocity magnitude and an initial velocity direction. The initial velocity direction may comprise coordinates that are indicative of a direction in which the manned VTOL aerial vehicle 100 is travelling. The initial velocity magnitude may be referred to as a speed.

The initial state estimate comprises an initial attitude vector. The initial attitude vector is indicative of the attitude of the manned VTOL aerial vehicle 100. In particular, the initial attitude vector is indicative of the attitude of the manned VTOL aerial vehicle 100 at the first time.

The at least one processor 132 determines an initial state estimate confidence metric. The initial state estimate confidence metric is indicative of an error associated with the initial state estimate. The at least one processor 132 determines the initial state estimate confidence metric based at least in part on one of the inputs used to determine the initial state estimate (e.g. the sensor data). For example, the at least one processor 132 may determine the initial state estimate confidence metric based at least in part on an error associated with one or more of the GNSS data, the altitude data, the accelerometer data, the gyroscopic data, the magnetic field data, the visible spectrum image data, the optical flow data, the LIDAR data and the RADAR data.

In some embodiments, the error is associated with the respective hardware component configured to generate the sensor data. For example, the at least one processor 132 may determine the initial state estimate confidence metric based at least in part on an error associated with the GNSS module 154, the altimeter 156, the inertial measurement unit 121, the accelerometer 158, the gyroscope 160, the magnetometer 162, the visible spectrum imaging module 166, the forward-facing camera 168, the downward-facing camera 170, the laterally-facing camera 165, the event-based camera 173, the optical flow camera 172, the LIDAR system 174 and the RADAR system 175.

In some embodiments, the method 200 further comprises receiving the external sensing system data generated by the external sensing system 199. The external sensing system data may comprise the initial state estimate and the initial state estimate confidence metric. The at least one processor 132 may determine the initial state estimate and the initial state estimate confidence metric by receiving the external sensing system data. The external sensing system data may comprise external sensing system image data, as previously described. The at least one processor 132 may determine the initial state estimate and the initial state estimate confidence metric based at least in part on the external sensing system data, for example, as is described herein with reference to the visible spectrum image data.

In some embodiments, the at least one processor 132 determines the initial state estimate confidence metric as described herein. For example, in some embodiments, the at least one processor 132 determines the initial state estimate confidence metric as described herein in relation to the state estimate confidence metric.

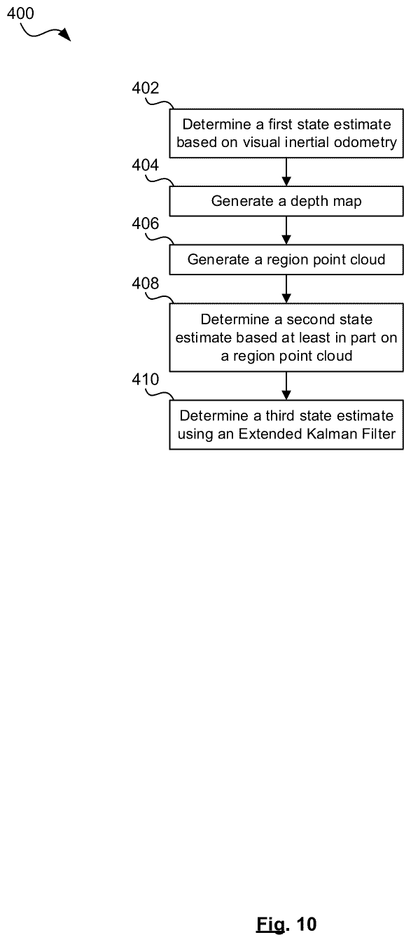

In some embodiments, the initial state estimate may be determined as described herein in relation to the state estimate. Therefore, the initial state estimate is determined based at least in part on the sensor data. As previously described, the sensor data may comprise one or more of the GNSS data, the altitude data, the acceleration data, the gyroscopic data, the magnetic field data and the image data. For example, in some embodiments, the initial state estimate may be determined as described in relation to FIG. 10. Specifically, the third state estimate described with reference to FIG. 10 may correspond to the initial state estimate. Further, the third state estimate confidence metric described with reference to FIG. 10 may correspond to the initial state estimate confidence metric.

In some embodiments, the at least one processor 132 executes one or more of the depth estimating module 135, the three-dimensional map module 136, the visual odometry module 137, the particle filter module, the region mapping module and the state estimating module 139 to determine the initial state estimate and the initial state estimate confidence metric.

At 304, the at least one processor 132 determines that GNSS data is unavailable. The at least one processor 132 may, for example, receive a signal from the GNSS module 154 indicating that the GNSS data is unavailable. The GNSS data may be unavailable, for example, in adverse weather conditions, when the manned VTOL aerial vehicle 100 is disposed in an area where there is poor satellite coverage (e.g. a valley, tunnel etc.), or upon failure of the GNSS module 154.

It can be important to estimate a position of the manned VTOL aerial vehicle 100 in cases where the GNSS data is unavailable.

In some embodiments, the at least one processor 132 executes the control module 141 to determine that GNSS data is unavailable.

At 306, the at least one processor 132 determines a motion estimate that is associated with the manned VTOL aerial vehicle 100. In particular, the at least one processor 132 determines a motion estimate that is indicative of motion of the manned VTOL aerial vehicle 100 between the first time and a second time. The second time is after the first time. The at least one processor 132 determines the motion estimate based at least in part on the sensor data.

The motion estimate comprises a motion estimate position estimate. The motion estimate position estimate is indicative of a change in position of the manned VTOL aerial vehicle 100 between the first time and the second time. The motion estimate comprises a motion estimate speed vector. The motion estimate speed vector is indicative of a change in velocity of the manned VTOL aerial vehicle 100 between the first time and the second time. The motion estimate comprises a motion estimate attitude vector. The motion estimate attitude vector is indicative of a change in attitude of the manned VTOL aerial vehicle between the first time and the second time.

The GNSS data may be available at the first time and unavailable at the second time.

The at least one processor 132 determines the motion estimate based at least in part on the sensor data. Specifically, the at least one processor at least one processor 132 determines the sensor data at a first time. This may comprise determining one or more of the altitude data, the accelerometer data, the gyroscopic data, the magnetic field data and the image data at the first time. The at least one processor 132 determines the sensor data at a second time. This may comprise determining one or more of the altitude data, the accelerometer data, the gyroscopic data, the magnetic field data and the image data at the second time. The at least one processor 132 determines the motion estimate based at least in part on the sensor data at the first time and the sensor data at the second time. In other words, the at least one processor 132 determines the motion estimate based at least in part on one or more of the altitude data, the accelerometer data, the gyroscopic data, the magnetic field data and the image data at the first time and one or more of the altitude data, the accelerometer data, the gyroscopic data, the magnetic field data and the image data at the second time.

As previously described, the sensing system 120 comprises an imaging module 164. The imaging module 164 is configured to provide, to the at least one processor 132, image data that is associated with the region. The sensor data may comprise the image data. The image data may comprise one or more of the LIDAR data, the visible spectrum image data and the RADAR data as previously described.

The at least one processor 132 may determine the motion estimate based at least in part on one or more of the LIDAR data, the RADAR data and the visible spectrum image data. In some embodiments, the at least one processor 132 determines one or more of the LIDAR data, the RADAR data and the visible spectrum image data at the first time. The at least one processor 132 determines one or more of the LIDAR data, the RADAR data and the visible spectrum image data at the second time. The at least one processor determines the motion estimate based at least in part on one or more of the LIDAR data, the visible spectrum image data and the RADAR data at the first time and one or more of the LIDAR data, the visible spectrum image data and the RADAR data at the second time. The at least one processor 132 may execute visual odometry to determine the motion estimate.

In some embodiments, at least one processor 132 determines a longitudinal velocity estimate that is indicative of a longitudinal velocity of the manned VTOL aerial vehicle 100. The at least one processor 132 determines the longitudinal velocity estimate based at least in part on image data captured by the ground-facing camera (e.g. the downward-facing camera 170) mounted on the manned VTOL aerial vehicle 100. The at least one processor 132 determines an acceleration estimate that is indicative of an acceleration of the manned VTOL aerial vehicle 100, based at least in part on the accelerometer data provided by the accelerometer 158. The at least one processor 132 determines an orientation estimate that is indicative of an orientation of the manned VTOL aerial vehicle 100, based at least in part on the gyroscopic data provided by the gyroscope 160. The at least one processor 132 determines an altitude estimate that is indicative of an altitude of the manned VTOL aerial vehicle 100, based at least in part on the altitude data provided by the altimeter 156. The at least one processor 132 determines an azimuth orientation estimate of the manned VTOL aerial vehicle 100, based at least in part on the magnetic field data provided by the magnetometer sensor 162. The at least one processor 132 determines the motion estimate based at least in part on one or more of the longitudinal velocity estimate, the acceleration estimate, the orientation estimate, the azimuth orientation estimate and the altitude estimate.

In some embodiments, the at least one processor 132 determines the motion estimate based at least in part on an egomotion estimate. The at least one processor 132 determines the egomotion estimate based at least in part on image data captured by the forward-facing camera 168 mounted on the manned VTOL aerial vehicle 100. In particular, the at least one processor 132 determines the egomotion estimate based at least in part on image data captured by the forward-facing camera 168 between the first time and the second time.

The at least one processor 132 determines an acceleration estimate that is indicative of an acceleration of the manned VTOL aerial vehicle 100, based at least in part on the accelerometer data provided by the accelerometer 158. In particular, the at least one processor 132 determines an acceleration estimate that is indicative of an acceleration of the manned VTOL aerial vehicle 100, based at least in part on the accelerometer data provided by the accelerometer 158 between the first time and the second time.

The at least one processor 132 determines an orientation estimate that is indicative of an orientation of the manned VTOL aerial vehicle 100, based at least in part on the gyroscopic data provided by the gyroscope 160. In particular, the at least one processor 132 determines an orientation estimate that is indicative of an orientation of the manned VTOL aerial vehicle 100, based at least in part on the gyroscopic data provided by the gyroscope 160 between the first time and the second time.

The at least one processor 132 determines altitude data that is indicative of the altitude of the manned VTOL aerial vehicle 100, based at least in part on the altitude data provided by the altimeter 156. In particular, the at least one processor 132 determines altitude data that is indicative of the altitude of the manned VTOL aerial vehicle 100, based at least in part on the altitude data provided by the altimeter 156 between the first time and the second time.

The at least one processor 132 determines an azimuth orientation estimate of the manned VTOL aerial vehicle 100, based at least in part on the magnetic field data provided by the magnetometer sensor 162. In particular, the at least one processor 132 determines an azimuth orientation estimate of the manned VTOL aerial vehicle 100, based at least in part on the magnetic field data provided by the magnetometer sensor 162 between the first time and the second time.

The at least one processor 132 determines the motion estimate based at least in part on one or more of the egomotion estimate, the acceleration estimate, the orientation estimate, the altitude estimate and the azimuth orientation estimate. In particular, the at least one processor 132 determines the motion estimate based at least in part on one or more of the egomotion estimate, the acceleration estimate, the orientation estimate, the altitude estimate and the azimuth orientation estimate between the first time and the second time.

In some embodiments, the at least one processor 132 executes the collision avoidance module 140 to determine that GNSS data is unavailable.

At 308, the at least one processor 132 determines an updated state estimate based at least in part on the initial state estimate and the motion estimate. The at least one processor 132 may add the motion estimate to the initial state estimate to determine the updated state estimate.

The updated state estimate comprises an updated position estimate. The updated position estimate is indicative of an updated position of the manned VTOL aerial vehicle within the region at the second time. The updated state estimate comprises an updated speed vector. The updated speed vector is indicative of an updated velocity of the manned VTOL aerial vehicle at the second time. The updated state estimate comprises an updated attitude vector. The updated attitude vector is indicative of an updated attitude of the manned VTOL aerial vehicle at the second time.

In some embodiments, the at least one processor 132 determines an object state estimate as previously described. That is, the object state estimate is indicative of a position of the object 113. The object state estimate is indicative of a velocity of the object 113. The object state estimate is indicative of an attitude of the object 113. The at least one processor 132 determines the object state estimate using the three-dimensional point cloud. Alternatively, the at least one processor 132 receives the object state estimate from another computing device (e.g. the central server system 103). In some embodiments, the external sensing system data comprises the object state estimate.

The at least one processor 132 executes the region mapping module 159 to determine the object state estimate.

The at least one processor 132 may control the propulsion system 106 of the manned VTOL aerial vehicle 100 to avoid the object 113 (or the plurality of objects 113, where relevant). In particular, the at least one processor 132 may control the propulsion system 106 of the manned VTOL aerial vehicle 100 to avoid the object 113 based at least in part on the updated state estimate. The at least one processor 132 controls the propeller drive systems 114 to rotate the propellers as necessary to control the manned VTOL aerial vehicle in accordance with a control vector. The at least one processor 132 determines the control vector based at least in part on the updated state estimate. In some embodiments, the at least one processor 132 controls the propulsion system 106 of the manned VTOL aerial vehicle 100 such that the manned VTOL aerial vehicle 100 avoids colliding with the object, based at least in part on the updated state estimate and the object state estimate.

In some embodiments, the at least one processor 132 executes the control module 141 to control the propulsion system 106 the manned VTOL aerial vehicle 100 to avoid the object 113.

### Computer-Implemented Method 400 for Determining a State Estimate of the Manned VTOL Aerial Vehicle

FIG. 10 is a process flow diagram illustrating a computer-implemented method 400 for determining a state estimate of the manned VTOL aerial vehicle 100 (e.g. the initial state estimate described herein), according to some embodiments. The computer-implemented method 400 is performed by the control system 116. In some embodiments, the computer-implemented method 400 is performed by the at least one processor 132.

FIG. 10 is to be understood as a blueprint for one or more software programs and may be implemented step-by-step, such that each step in FIG. 10 may, for example, be represented by a function in a programming language, such as C++ or Java. The resulting source code is then compiled and stored as computer executable instructions on memory 134.

At 402, the at least one processor 132 determines a first state estimate. The at least one processor 132 also determines a first state estimate confidence metric. The at least one processor 132 determines the first state estimate based at least in part on visual odometry. In particular, the at least one processor 132 determines the first state estimate based at least in part on one or more of the gyroscopic data, the accelerometer data, the altitude data, the magnetic field data and the visible spectrum image data. The first state estimate is indicative of a first position, a first attitude and a first velocity of the manned VTOL aerial vehicle 100 within the region (and therefore, the three-dimensional model of the region). The first state estimate confidence metric is indicative of a first error associated with the first state estimate.

The at least one processor 132 executes the visual odometry module 137 to determine the first state estimate and the first state estimate confidence metric.

At 404, the at least one processor 132 generates a depth map. The depth map is associated with the region. The at least one processor 132 generates the depth map based at least in part on the visible spectrum image data. In some embodiments, the at least one processor 132 generates the depth map using a deep neural network (DNN). The visible spectrum image data may be an input of the DNN.

The at least one processor 132 executes the depth estimating module 135 to generate the depth map. The depth estimating module 135 may be in the form of a DNN trained to recognise depth.

At 406, the at least one processor 132 generates a region point cloud. The region point cloud is associated with the region. In some embodiments, the region point cloud represents the region. In some embodiments, the region point cloud corresponds to the previously described three-dimensional point cloud. The at least one processor 132 generates the region point cloud based at least in part on the depth map and the LIDAR data. Outlier points of the depth map and/or the LIDAR data are excluded from the region point cloud.

For example, the LIDAR data may comprise a plurality of LIDAR points. Each LIDAR point is associated with three-dimensional LIDAR point coordinates and a LIDAR point intensity. The intensity may be proportional to a LIDAR point reflectivity. Each intensity is indicative of a reflectivity of a corresponding point of the region on which the LIDAR signal is reflected. Therefore, the LIDAR points may be filtered based at least in part on their intensity. The at least one processor 132 may filter the LIDAR points by excluding LIDAR points with a LIDAR point intensity that is below a LIDAR intensity threshold from further processing. The at least one processor 132 may discard these LIDAR points from the LIDAR data.

The region point cloud comprises a plurality of points. The points of the region point cloud may be region point cloud vectors. Each point is associated with three-dimensional coordinates and an intensity. Each intensity is indicative of a reflectivity of a corresponding point of the region or a surface of an object within the region. Therefore, the points may be filtered based at least in part on their intensity. The at least one processor 132 may filter the points by excluding points with an intensity that is below an intensity threshold from further processing. The at least one processor 132 may discard these points from the region point cloud.

The depth map comprises a plurality of points. The points may be pixels. The points of the depth map may be depth map vectors. Each point is associated with coordinates and a value. The coordinates may be two-dimensional coordinates. Each value is indicative of a reflectivity of a corresponding point on a surface of the region or a surface of an object within the region. Therefore, the points may be filtered based at least in part on their value. The at least one processor 132 may filter the points by excluding points with a value that is below a value threshold from further processing. The at least one processor 132 may discard these points from the region point cloud.

The at least one processor 132 may merge the depth map and the LIDAR data to determine the region point cloud. The at least one processor 132 determines the region point cloud by including the points of the depth map and the points of the LIDAR data in a single point cloud. The at least one processor 132 may convert the depth map to a depth map point cloud based at least in part on the values of each of the points of the depth map. By expressing the LIDAR data and the depth map point cloud in a common reference frame (e.gt. that of the manned VTOL aerial vehicle 100), the at least one processor determines the region point cloud. The region point cloud comprises a plurality of region point cloud points. The region point cloud points may be region point cloud vectors. Each region point cloud point is associated with an elevation, azimuth and ranging.

The at least one processor 132 executes the three-dimensional map module 136 to generate the region point cloud.

At 408, the at least one processor 132 determines a second state estimate. The at least one processor 132 also determines a second state estimate confidence metric. The at least one processor 132 determines the second state estimate and the second state estimate confidence metric based at least in part on the region point cloud, the first state estimate and the first state estimate confidence metric. The at least one processor 132 may determine the second state estimate and/or the second state estimate confidence interval based at least in part on the external sensing system data. The second state estimate is indicative of a second position, a second attitude and a second velocity of the manned VTOL aerial vehicle within the region. The second state estimate confidence metric is indicative of a second error associated with the second state estimate.

The at least one processor 132 executes a three-dimensional adaptive Monte Carlo localisation to determine the second state estimate and the second state estimate confidence metric. The region point cloud, the first state estimate and the first state estimate confidence metric are inputs of the three-dimensional adaptive Monte Carlo localisation. The second state estimate and the second state estimate confidence interval are outputs of the three-dimensional adaptive Monte Carlo localisation. The external LIDAR data is an input of the three-dimensional adaptive Monte Carlo localisation.

The at least one processor 132 executes the particle filter module 138 to determine the second state estimate and the second state estimate confidence metric.

In some embodiments, the external sensing system data comprises the second state estimate and/or the second state estimate confidence interval.

In some embodiments, the second state estimate corresponds to the previously mentioned state estimate. In some embodiments, the second state estimate confidence metric corresponds to the previously mentioned state estimate confidence metric.

At 410, the at least one processor 132 determines a third state estimate. The at least one processor 132 also determines a third state estimate confidence metric. The third state estimate comprises a position estimate that is indicative of a position of the manned VTOL aerial vehicle within the region. The third state estimate comprises a speed vector that is indicative of a velocity of the manned VTOL aerial vehicle 100. The third state estimate comprises an attitude vector that is indicative of an attitude of the manned VTOL aerial vehicle 100. The third state estimate confidence metric is indicative of a third error associated with the third state estimate.

The least one processor 132 determines the third state estimate and the third state estimate confidence metric based at least in part on the GNSS data. The least one processor 132 determines the third state estimate and the third state estimate confidence metric based at least in part on the gyroscopic data. The least one processor 132 determines the third state estimate and the third state estimate confidence metric based at least in part on the accelerometer data. The least one processor 132 determines the third state estimate and the third state estimate confidence metric based at least in part on the altitude data. The least one processor 132 determines the third state estimate and the third state estimate confidence metric based at least in part on the magnetic field data. The least one processor 132 determines the third state estimate and the third state estimate confidence metric based at least in part on the second state estimate. The least one processor 132 determines the third state estimate and the third state estimate confidence metric based at least in part on the second state estimate confidence metric. The at least one processor 132 may determine the third state estimate and/or the third state estimate confidence interval based at least in part on the external sensing system data.

In some embodiments, the at least one processor 132 determines the third state estimate and the third state estimate confidence metric using an Extended Kalman Filter. The second state estimate is an input of the Extended Kalman Filter. The second state estimate confidence metric is an input of the Extended Kalman Filter. The gyroscopic data is an input of the Extended Kalman Filter. The accelerometer data is an input of the Extended Kalman Filter. The altitude data is an input of the Extended Kalman Filter. The magnetic field data is an input of the Extended Kalman Filter. The GNSS data is an input of the Extended Kalman Filter

In some embodiments, the at least one processor 132 receives a ground-based state estimate. The ground-based state estimate is indicative of a state of the manned VTOL aerial vehicle 100. The ground-based state estimate comprises a ground-based position estimate. The ground-based position estimate is indicative of the position of the manned VTOL aerial vehicle 100 within the region. The ground-based state estimate comprises a ground-based speed vector. The ground-based speed vector is indicative of the velocity of the manned VTOL aerial vehicle 100. The ground-based state estimate comprises a ground-based attitude vector. The ground-based attitude vector is indicative of the attitude of the manned VTOL aerial vehicle 100.

The ground-based state estimate may be determined by another computing system. For example, the central server system 103 may generate the ground-based state estimate by processing ground-based LIDAR data generated by a ground-based LIDAR system (e.g. the external sensing system 199). Alternatively, the central server system 103 may generate the ground-based state estimate by processing ground-based visual spectrum image data generated by a ground-based visual spectrum image camera. In other words, the external sensing system data may comprise the ground-based state estimate. In some embodiments, the ground-based state estimate is an input of the Extended Kalman Filter.

In some embodiments, each of the inputs of the Extended Kalman Filter may be associated with a respective frequency. For example, the second state estimate may be updated at a second state estimate frequency. The second state estimate confidence metric may be updated at a second state estimate confidence metric frequency. The gyroscopic data may be updated (e.g. provided by the gyroscope 160) at a gyroscopic data frequency. The accelerometer data may be updated (e.g. provided by the accelerometer 158) at an accelerometer data frequency. The altitude data may be updated (e.g. provided by the altimeter 156) at an altitude data frequency. The magnetic field data may be updated (e.g. provided by the magnetometer sensor 162) at a magnetic field data frequency. The ground-based state estimate may be updated at a ground-based state estimate frequency. These frequencies may be referred to as Extended Kalman Filter input frequencies. One or more of these frequencies may be the same. One or more of these frequencies may be different.

In some embodiments, the at least one processor 132 outputs the third state estimate and the third state estimate confidence interval at a third state estimate frequency and a third state estimate confidence interval frequency respectively. These may be referred to as Extended Kalman Filter output frequencies. These frequencies may be the same. This frequency may be the same as a frequency of the state estimate described herein and the state estimate confidence metric described herein. In this case, the relevant frequency may be referred to as the Extended Kalman Filter output frequency. In some embodiments, the Extended Kalman Filter output frequencies are the same as one or more of the Extended Kalman Filter input frequencies. In some embodiments, the Extended Kalman Filter output frequencies are different to one or more of the Extended Kalman Filter input frequencies.

As previously described, the third state estimate and the third state estimate confidence metric may be the initial state estimate and the initial state estimate confidence metric described herein. The at least one processor 132 executes the state estimating module 139 to determine the third state estimate and the third state estimate confidence metric.

In some embodiments, the third state estimate is the state estimate referred to in the previously described computer-implemented method 200.

The manned VTOL aerial vehicle 100, the computer-implemented method 200, the computer-implemented method 300 and the computer-implemented method 400 provide a number of significant technical advantages. As the GNSS module 154 is capable of RTK correction, a global localisation problem is solved. That is, the at least one processor 132 is capable of accurately determining the position estimate and the speed vector. In some embodiments, the GNSS module 154 comprises two or more antennae. Thus, the at least one processor 132 can determine the azimuth of the manned VTOL aerial vehicle 100.

In some cases, the GNSS signal can be impeded. For example, when the manned VTOL aerial vehicle 100 is flying near large obstacles or indoors. In these cases, the IMU 121 provides sensor data that enable the at least one processor 132 to determine the state estimate.

According to some embodiments, when the GNSS data is not available or not accurate, the at least one processor 132 is capable of using the disclosed inertial odometry to provide the state estimate, but this estimation becomes inaccurate over time. Visual odometry module 137 can be used to further improve the accuracy of the state estimates provided by the at least one processor 132 and limit the estimation drift. By exploiting the sensor data (e.g. the LIDAR data) and a pre-determined three-dimensional model of the region, only the states that satisfy a close correlation between predictions and observation are kept. This is the role of the particle filter module 138. According to some embodiments, when the GNSS data is not available or not accurate, the at least one processor 132 is capable of using the disclosed particle filter based algorithm to provide the state estimate by exploiting the correlation between sensor data (e.g. the LIDAR data and the depth map) and a pre-determined three-dimensional model of the region. Visual odometry is used to periodically provide the particle filter with estimated position and angular motions, further improving the accuracy of the state estimates provided by the at least one processor 132.

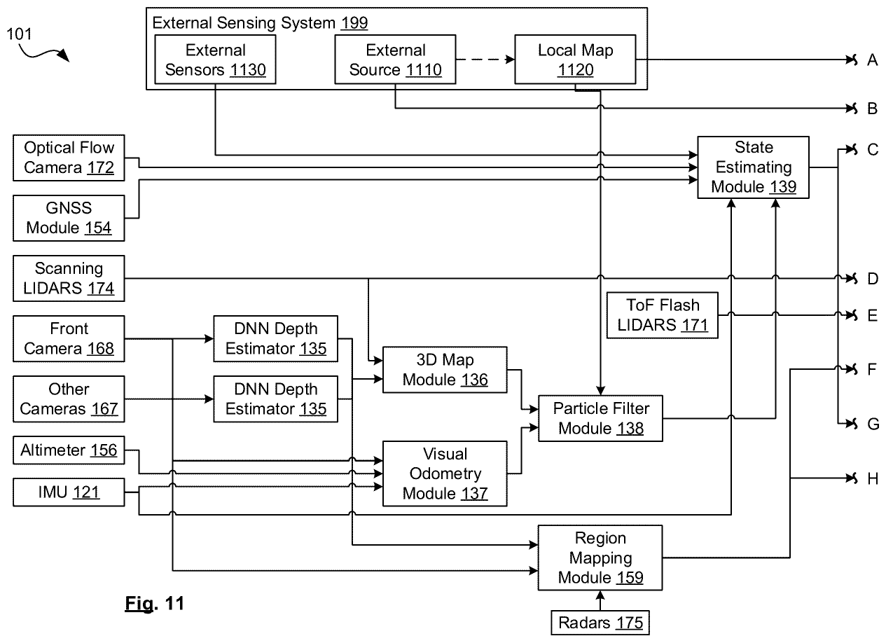

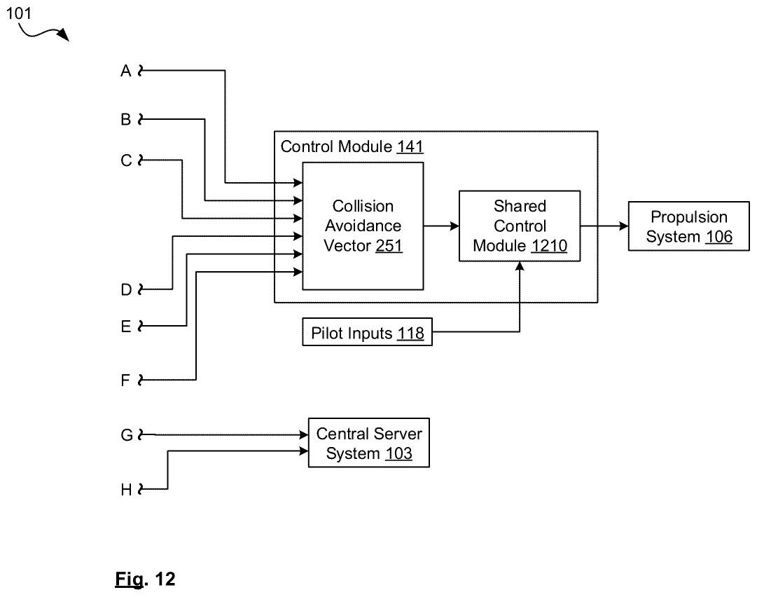

FIG. 11 and FIG. 12 illustrate an example control system 116, according to some embodiments. FIG. 11 illustrates a first portion of the control system 116. FIG. 12 illustrates a second portion of the control system 116. Reference letters A-H indicate a continuation of a line from FIG. 11 to FIG. 12. For example, the line of FIG. 11 marked with “A” is continued at the corresponding “A” on FIG. 12. Similar logic also applies to each of “B” through “H” on FIGS. 11 and 12.

As previously described, the control system 116 comprises the sensing system 120. The illustrated control system comprises the IMU 121. The IMU 121 comprises the magnetometer 162, the altimeter 156, the accelerometer 158 and the gyroscope 160. Alternatively, the altimeter 156 is separate from the IMU 121. The IMU 121 provides sensor data to the visual odometry module 137 and the state estimating module 139. Optionally, optical flow camera 172 provides further image data output to the visual odometry module 137.

The forward-facing camera 168 provides visible spectrum image data to the depth estimating module 135. The other visible spectrum cameras 167 also provide visible spectrum image data to the depth estimating module/s 135. As illustrated, the control system 116 may comprise a plurality of depth estimating modules 135. The depth estimating modules 135 provide depth maps to the three-dimensional map module 136 which generates the region point cloud (also referred to as the three-dimensional point cloud) as previously described. The depth estimating module/s 135 provide depth maps to the region mapping module 175.

The at least one processor 132 determines the first state estimate and the first state estimate confidence interval by executing the visual odometry module 137 (which may also be referred to as the state estimate and the state estimate confidence metric, when referring to computer-implemented method 200) as described herein. The at least one processor 132 determines the second state estimate and the second state estimate confidence interval based at least in part on the region point cloud, the first state estimate and the first state estimate confidence interval as described herein. In some embodiments, the second state estimate corresponds to the updated state estimate described with reference to the computer-implemented method 200.

The at least one processor 132 executes the state estimating module 139 to determine the third state estimate and the third state estimate confidence interval based at least in part on the second state estimate and the second state estimate confidence interval. The at least one processor 132 may determine the third state estimate and the third state estimate confidence interval based at least in part on optical flow data provided by the visible spectrum cameras 167 and/or optical flow camera 172, GNSS data provided by the GNSS module 154, altitude data provided by the altimeter 156, inertial monitoring unit data provided by the IMU 121, and the external data provided by the external sensing system 199, as previously described.

As previously described, the manned VTOL aerial vehicle 100 may use external sensor data from the external sensing system 199 to perform functionality described herein. As shown in FIGS. 11 and 12, the external sensing system 199 may provide input from external sensors 1130, external source 1110, and local map module 1120. External sensors 1130 may include a ground based sensor or another speeder, for example. External sensors 1130 may provide absolute localisation or speeder state via vehicle-to-everything (V2X) communication. External source 1110 may comprise sources of point cloud data, no fly zone data, and virtual object data, for example. External source 1110 may provide data to local map module 1120. Local map module 1120 may use data provided by external source 1110 to generate and provide point cloud data to the control module 141. The external sensing system 199 may provide point cloud data to the particle filter module 138. The external sensing system may also provide point cloud data to the region mapping module 159. The point cloud data may be, for example, the additional point cloud data previously described.

The at least one processor 132 executes the region mapping module 159 to determine the object state estimate as described herein. The at least one processor 132 executes the region mapping module 159 to determine an estimated region map as described herein. The at least one processor 132 determines the object position estimate and the estimated region map based at least in part on the visible spectrum image data provided by front camera 168 and other cameras 167, the depth map(s) provided by DNN depth estimators 135, the RADAR data provided by radars 175, and the external sensor data provided by the external sensing system 199. In this case, the external sensor data may comprise an additional vehicle state estimate that is indicative of a state of an additional vehicle. Such data may indicate that an additional vehicle is in the region, for example.

The at least one processor 132 executes the control module 141 to control the manned VTOL aerial vehicle 100 to avoid the object 113 as previously described. FIGS. 11 and 12 illustrate a relationship between the inputs to the control module 141, and a relationship between the control module 141 and the propulsion system 106 of the manned VTOL aerial vehicle 100. In some embodiments, the pilot may manipulate the pilot-operable controls to provide pilot inputs 118 to the control module 141, which may include angular rates and thrust. The control module 141 is configured to process pilot inputs 118 in combination with a collision avoidance velocity vector via shared control module 1210 to determine a control vector. This allows the pilot to control the manned VTOL aerial vehicle 100 while still within an overall autonomous collision-avoidance control program.

As illustrated in FIGS. 11 and 12, the manned VTOL aerial vehicle is configured to provide the object position estimate and/or the estimated region map to one or more other vehicles and/or the central server system 103. That is, other vehicles may be allowed access to the estimated region.

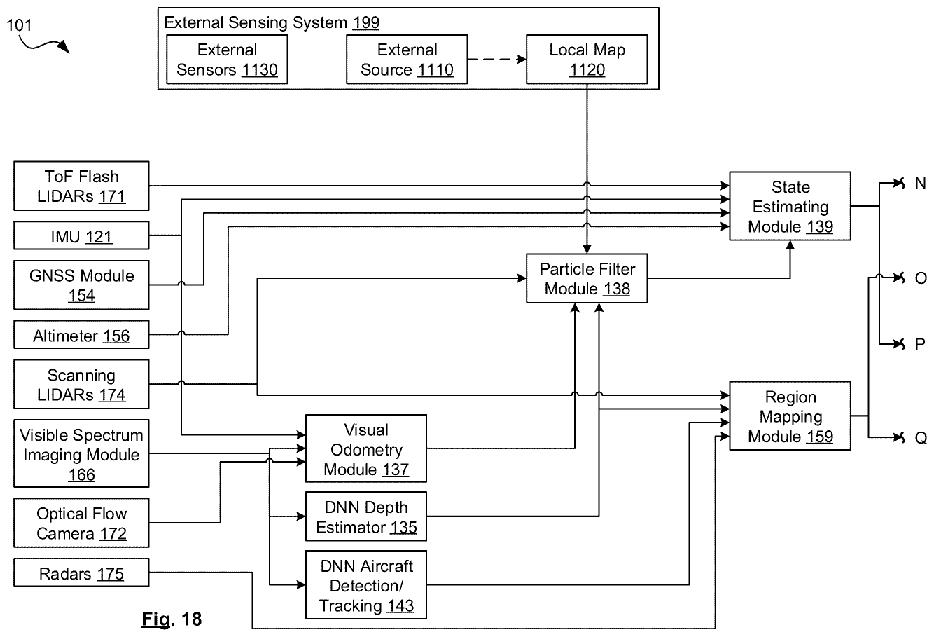

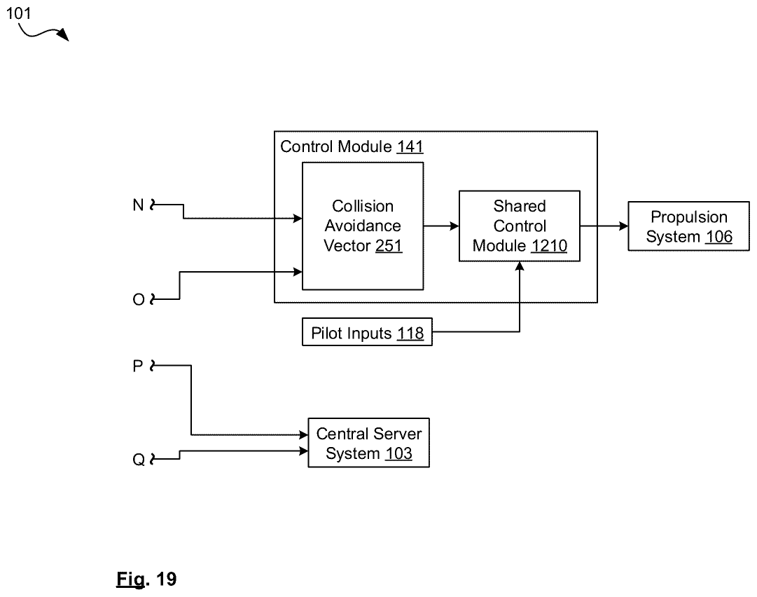

FIG. 18 and FIG. 19 illustrate an alternate example control system 116, according to some embodiments. FIG. 18 illustrates a first portion of the control system 116. FIG. 19 illustrates a second portion of the control system 116. Reference letters N-Q indicate a continuation of a line from FIG. 18 to FIG. 19. For example, the line of FIG. 18 marked with “N” is continued at the corresponding “N” on FIG. 19. Similar logic also applies to each of “O” through “Q” on FIGS. 18 and 19.

In some embodiments, the scanning LIDARS 174 is not an input to the control module 141. The scanning LIDARS 174 may be an input to region mapping module 159, and the particle filter module 138. In some embodiments, the DNN depth estimator 135 may be an input to the particle filter module. In some embodiments, the altimeter 156 may be a direct input to the state estimation module 139. That is, visual odometry module 137 may not determine the first state estimate using altitude from altimeter 156. In some embodiments, the DNN depth estimator 135 may be a direct input of particle filter module 138. In some embodiments, the DNN depth estimator 135 may or may not be required. In some embodiments, the optical flow camera 172 is not an input of the state estimation module 139. Optical flow camera may be an input of visual odometry module 137.

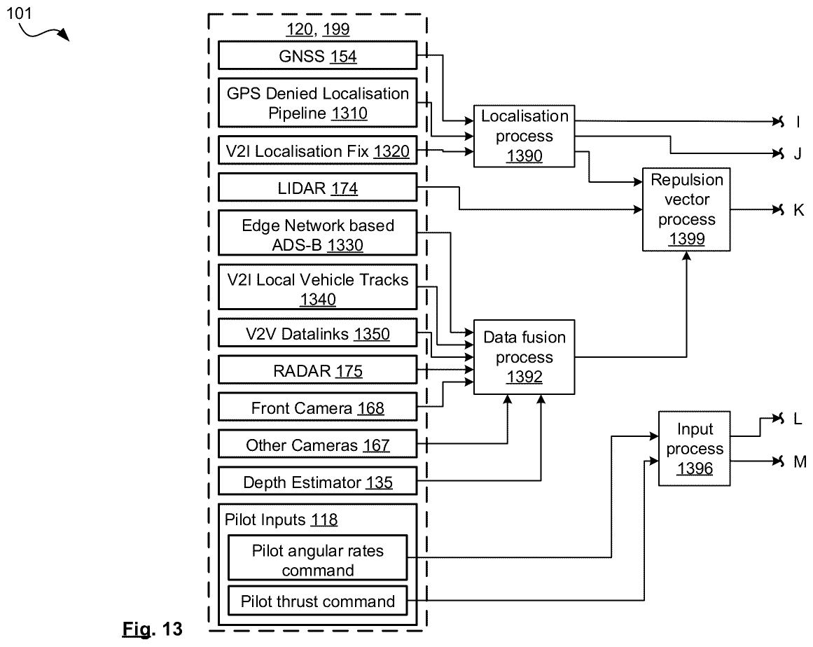

FIGS. 13 and 14 illustrate a schematic diagram of a plurality of components of the control system 116, a plurality of the steps of the computer-implemented method 200, a plurality of the steps of the computer-implemented method 300, and a plurality of the steps of the computer-implemented method 400. Specifically, FIG. 13 illustrates a first portion of the schematic diagram and FIG. 14 illustrates a second portion of the schematic diagram. Reference letters I-M indicate a continuation of a line from FIG. 13 to FIG. 14. For example, the line of FIG. 13 marked with “I” is continued at the corresponding “I” on FIG. 14. Similar logic also applies to each of “J” through “M” on FIGS. 13 and 14.

As shown in FIG. 13, the at least one processor 132, executing localisation process 1390, determines a state estimate comprising position, speed, attitude, velocity, and error estimation data outputs. In some embodiments, the localisation process 1390 receives inputs from GNSS 154, GPS denied localisation pipeline 1310, and vehicle-to-infrastructure (V2I) localisation fix 1320. In some embodiments, the speed and attitude data outputs of the localisation process 1390 may be input to the collision avoidance module 140 of FIG. 14. In some embodiments, all, or some, of the data outputs may be inputs to repulsion vector process 1399.

The at least one processor 132, executing data fusion process 1392, generates a repulsion potential field model or a region around the vehicle. In some embodiments, data fusion process 1392 receives input from Edge network based automatic dependent surveillance broadcast (ADS-B) 1330, V2I local vehicle tracks 1340, vehicle-to-vehicle (V2V) datalinks 1350, RADAR 175, front camera 168, other cameras 167, and depth estimator 135. In some embodiments, the repulsion potential field model may include position and velocity data outputs to repulsion vector process 1399. In some embodiments, LIDAR 174 may provide point cloud data to repulsion vector process 1399.

The at least one processor 132, executing repulsion vector process 1399, generates a state estimate of the manned VTOL aerial vehicle, and a repulsion potential field model of a region around the vehicle. Using the generate state estimate and repulsion potential field model, processor 132, executing repulsion vector process 1399, then determines a repulsion vector, as described in PCT/AU2021/051533. The at least one processor 132, executing input process 1396, determines an input vector. In some embodiments, the input vector is determined via inputs 118. In some embodiments, inputs 118 may provide thrust data, and pitch, yaw, and roll data. In some embodiments, input process 1396 may output thrust data to weight avoidance thrust module 1450, and pitch, yaw, and roll data to weight rates commands module 1430.

In FIG. 14 a collision avoidance velocity vector is determined by processor 132 by executing collision avoidance module 140. In some embodiments, the at least one processor 132 executes collision avoidance module 140, wherein the speed vector 253 and repulsion vector 254 are summed to determine the speed component of the collision avoidance velocity vector. Similarly, to determine the attitude components of the collision avoidance velocity vector, the repulsion vector and the attitude outputs of module 1390 are summed by the at least one processor 132.

The at least one processor 132 then scales the collision avoidance velocity vector attitude components with the attitude component of the pilot inputs 118 by executing weight rates command module 1430 and angular rate controller 1440 to determine a scaled collision avoidance velocity vector as described in PCT/AU2021/051533. The at least one processor 132 also scales the collision avoidance velocity vector speed component with the thrust component of the pilot inputs 118 by executing weight avoidance thrust module 1450 to determine a scaled input vector as previously described. The scaled collision avoidance velocity vector components are then added together via motor mixer 1460 when executed by the at least one processor 132. The resulting control vector is then processed by processer 132 to control the propulsion system 116 of the vehicle to avoid an object 113.

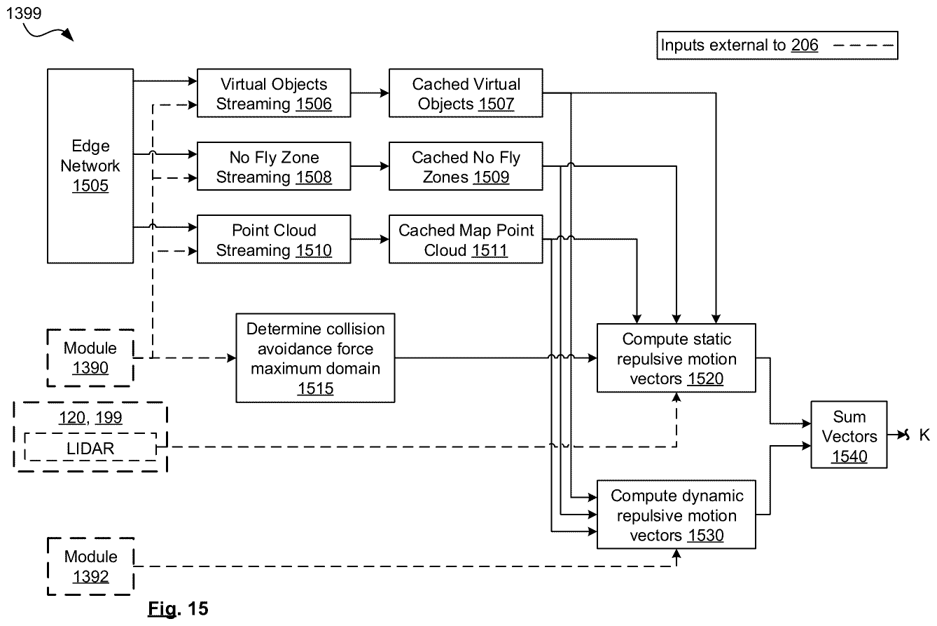

FIG. 15 illustrates a schematic diagram of the repulsion vector process 1399 of FIG. 13, performed by the at least one processor 132. At 1399, a repulsion vector is determined via processing inputs provided by localisation process 1390, sensing system 120, the data fusion process 1392, and edge network 1905, as previously described. When executed by the at least one processor 132, the repulsion vector process 1399 computes the static components of the repulsive motion vectors at 1520, and the dynamic components of the repulsive motion vectors at 1530. These components are then summed by the at least one processor 132 at 1540 to determine the repulsion vector.

In some embodiments, the edge network 1505 provides position, orientation, and 3D modelling data virtual objects streaming 1506, 3D area streaming and GeoJson date to no fly zone streaming 1508, and point stream data to point cloud streaming 1505.

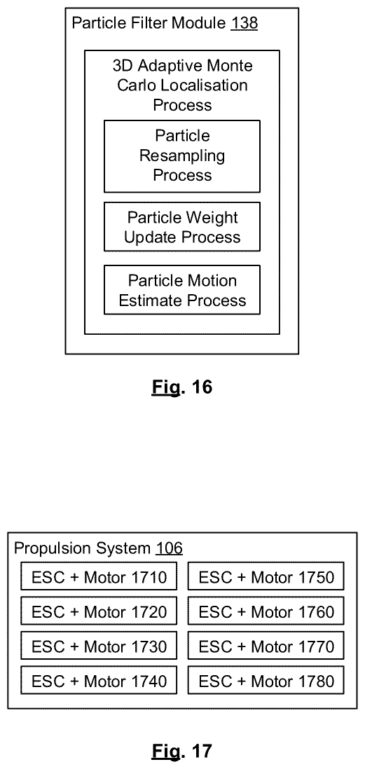

FIG. 16 is a schematic diagram of a portion of the control system 116, specifically particle filter module 138. Particle filter module 138 utilises three-dimensional adaptive Monte Carlo localisation to determine a second state estimate and a second state estimate confidence interval as described herein.

FIG. 17 is a block diagram of propulsion system 106 according to some embodiments. Propulsion system 106 may comprise a plurality of electronic speed controller (ESC) and motor pairs 1710, 1720, 1730, 1740, 1750, 1760, 1770, and 1780. The four ESC and motor pairs are used to control pairs of the propellers. Propulsion system 106 is carried by the body 102 to propel the body 102 during flight.

### Alternative Control System 116 Architecture

Although the manned VTOL aerial vehicle 100 has been described with reference to the control system 116 of FIG. 4, it will be understood that the manned VTOL aerial vehicle 100 may comprise alternative control system 116 architecture. FIG. 5 illustrates an alternative control system 116, according to some embodiments.

FIG. 5 is a block diagram of the control system 116, according to some embodiments. The control system 116 illustrated in FIG. 5 comprises a first control system 142 and a second control system 144. The first control system 142 comprises at least one first control system processor 146. The at least one first control system processor 146 is configured to be in communication with first control system memory 148. The sensing system 120 is configured to communicate with the at least one first control system processor 146. The sensing system 120 may be as previously described. In some embodiments, the sensing system 120 is configured to provide the sensor data to the at least one first control system processor 146. In some embodiments, the at least one first control system processor 146 is configured to receive the sensor data from the sensing system 120. In some embodiments, the at least one first control system processor 146 is configured to retrieve the sensor data from the sensing system 120. The at least one first control system processor 146 is configured to store the sensor data in the first control system memory 148.

The at least one first control system processor 146 is configured to execute first control system program instructions stored in first control system memory 148 to cause the first control system 142 to function as described herein. In particular, the at least one first control system processor 146 is configured to execute the first control system program instructions to cause the manned VTOL aerial vehicle 100 to function as described herein. In other words, the first control system program instructions are accessible by the at least one first control system processor 146, and are configured to cause the at least one first control system processor 146 to function as described herein.

In some embodiments, the first control system program instructions are in the form of program code. The at least one first control system processor 146 comprises one or more microprocessors, central processing units (CPUs), application specific instruction set processors (ASIPs), application specific integrated circuits (ASICs), graphics processing units (GPUs), tensor processing units (TPUs), field-programmable gate arrays (FPGAs) or other processors capable of reading and executing program code. The first control system program instructions comprise the depth estimating module 135, the three-dimensional map module 136, the visual odometry module 137, the particle filter module 138, the region mapping module 159 and the collision avoidance module 140.

First control system memory 148 may comprise one or more volatile or non-volatile memory types. For example, first control system memory 148 may comprise one or more of random access memory (RAM), read-only memory (ROM), electrically erasable programmable read-only memory (EEPROM) or flash memory. First control system memory 148 is configured to store program code accessible by the at least one first control system processor 146. The program code may comprise executable program code modules. In other words, first control system memory 148 is configured to store executable code modules configured to be executable by the at least one first control system processor 146. The executable code modules, when executed by the at least one first control system processor 146 cause the at least one first control system processor 146 to perform certain functionality, as described herein. In the illustrated embodiment, the depth estimating module 135, the three-dimensional map module 136, the visual odometry module 1137, the particle filter module 138, the DNN detection and tracking module 143, the region mapping module 159, and the collision avoidance module 140 are in the form of program code stored in the first control system memory 138.

The second control system 144 comprises at least one second control system processor 150. The at least one second control system processor 150 is configured to be in communication with second control system memory 152. The sensing system 120 is configured to communicate with the at least one second control system processor 150. The sensing system 120 may be as previously described. The at least one second control system processor 150 is configured to execute second control system program instructions stored in second control system memory 152 to cause the second control system 144 to function as described herein. In particular, the at least one second control system processor 150 is configured to execute the second control system program instructions to cause the manned VTOL aerial vehicle 100 to function as described herein. In other words, the second control system program instructions are accessible by the at least one second control system processor 150, and are configured to cause the at least one second control system processor 150 to function as described herein.

In some embodiments, the second control system 144 comprises some or all of the sensing system 120. The control system 120 may be as previously described. The sensing system 120 is configured to communicate with the at least one second control system processor 150. In some embodiments, the sensing system 120 is configured to provide the sensor data to the at least one second control system processor 150. In some embodiments, the at least one second control system processor 150 is configured to receive the sensor data from the sensing system 120. In some embodiments, the at least one second control system processor 150 is configured to retrieve the sensor data from the sensing system 120. The at least one second control system processor 150 is configured to store the sensor data in the second control system memory 152.

In some embodiments, the second control system program instructions are in the form of program code. The at least one second control system processor 150 comprises one or more microprocessors, central processing units (CPUs), application specific instruction set processors (ASIPs), application specific integrated circuits (ASICs), graphics processing units (GPUs), tensor processing units (TPUs), field-programmable gate arrays (FPGAs) or other processors capable of reading and executing program code. The second control system program instructions comprise the state estimating module 139, the cockpit warning module 161 and the control module 141.

Second control system memory 152 may comprise one or more volatile or non-volatile memory types. For example, second control system memory 152 may comprise one or more of random access memory (RAM), read-only memory (ROM), electrically erasable programmable read-only memory (EEPROM) or flash memory. Second control system memory 152 is configured to store program code accessible by the at least one second control system processor 150. The program code may comprise executable program code modules. In other words, second control system memory 152 is configured to store executable code modules configured to be executable by the at least one second control system processor 150. The executable code modules, when executed by the at least second control system processor 150 cause the at least one second control system processor 150 to perform certain functionality, as described herein. In the illustrated embodiment, the control module 140 and the state estimating module 139 are in the form of program code stored in the second control system memory 152.

The first control system 142 is configured to communicate with the second control system 144. The first control system 142 may comprise a first control system network interface (not shown). The first control system network interface is configured to enable the first control system 142 to communicate with the second control system 144 over one or more communication networks. In particular, the first control system processor 146 may be configured to communicate with the second control system processor 150 using the first control system network interface. The first control system 142 may comprise a combination of network interface hardware and network interface software suitable for establishing, maintaining and facilitating communication over a relevant communication channel. Examples of a suitable communications network include a communication bus, cloud server network, wired or wireless network connection, a wireless local area network (WLAN) such as Wi-Fi (IEEE 82.15.1) or Zigbee (IEE 802.15.4), a wireless wide area network (WWAN) such as cellular 4G LTE and 5G or another cellular network connection, low power wide area networks (LPWAN) such as SigFox and Lora, Bluetooth™ or other near field radio communication, and/or physical media such as a Universal Serial Bus (USB) connection.

The second control system 144 may comprise a second control system network interface (not shown). The second control system network interface is configured to enable the second control system 144 to communicate with the first control system 142 over one or more communication networks. In particular, the second control system processor 150 may be configured to communicate with the first control system processor 146 using the second control system network interface. The second control system 144 may comprise a combination of network interface hardware and network interface software suitable for establishing, maintaining and facilitating communication over a relevant communication channel. Examples of a suitable communications network include a communication bus, cloud server network, wired or wireless network connection, a wireless local area network (WLAN) such as Wi-Fi (IEEE 82.15.1) or Zigbee (IEE 802.15.4), a wireless wide area network (WWAN) such as cellular 4G LTE and 5G or another cellular network connection, low power wide area networks (LPWAN) such as SigFox and Lora, Bluetooth™ or other near field radio communication, and/or physical media such as a Universal Serial Bus (USB) connection.

The first control system 142 may be considered a high-level control system. That is, the first control system 142 may be configured to perform computationally expensive tasks. The second control system 144 may be considered a low-level control system. The second control system 144 may be configured to perform computationally less-expensive tasks than the first control system 144.

The computer implemented method 200 may be executed by the control system 116 of FIG. 5. In some embodiments, one or more of steps 202, 204, 206 and 208 are executed by the first control system processor 146. In some embodiments, one or more of steps 202, 204, 206 and 208 are executed by the second control system processor 150.

The computer-implemented method 300 may be executed by the control system 116 of FIG. 5. In some embodiments, one or more of steps 302, 304, 306 and 308 are executed by the first control system processor 146. In some embodiments, one or more of steps 302, 304, 306 and 308 are executed by the second control system processor 150.

The computer-implemented method 400 may be executed by the control system 116 of FIG. 5. In some embodiments, one or more of steps 402, 404, 406, 408 and 410 are executed by the first control system processor 146. In some embodiments, one or more of steps 402, 404, 406, 408 and 410 are executed by the second control system processor 150.

In particular, the first control system processor 146 is configured to at least partially determine the state estimate of the manned VTOL aerial vehicle 100 (step 202), generate the three-dimensional point cloud of the region around the vehicle (step 204), generate a plurality of virtual particles within a three-dimensional model, around the state estimate (step 206), compute a score for each particle (step 208) and update the state estimate (step 210).

The second control system processor 150 is configured to control the propulsion system 106 to avoid the object 113.

In particular, the first control system processor is configured to at least partially determine the initial state estimate and the initial state estimate confidence metric (step 302), determine that GNSS data is unavailable (step 304), determine the motion estimate associated with the manned VTOL aerial vehicle (step 306) and determine the updated state estimate based at least in part on the motion estimate and the initial state estimate.

The second control system processor 150 is configured to at least partially determine the initial state estimate and the initial state estimate confidence metric (step 302) and to control the propulsion system 106 to avoid the object 113.

With reference to the computer-implemented method 400 (i.e. determining the state estimate), the first control system processor 146 is configured to determine the first state estimate (step 402), generate the depth map (step 404), generate the region point cloud (step 406) and determine the second state estimate (step 408).

The second control system processor 150 is configured to determine the third state estimate using the Extended Kalman Filter (step 410).

### Alternative Piloting System

In some embodiments, a VTOL aerial vehicle may be piloted remotely. The VTOL aerial vehicle may comprise one or more of the features previously described with reference to the manned VTOL aerial vehicle 100. The VTOL aerial vehicle may comprise a remote cockpit rather than the cockpit 104 described with reference to the manned VTOL aerial vehicle 100. The remote cockpit 104 may be in a different location to that of the VTOL aerial vehicle. For example, the remote cockpit 104 may be in a room that is separated from the VTOL aerial vehicle (e.g. a cockpit replica ground station).

The remote cockpit 104 can be similar or identical to the cockpit 104. That is, the remote cockpit 104 may comprise the pilot-operable controls 118. The remote cockpit 104 may comprise a remote cockpit communication system. The remote cockpit communication system is configured to enable the remote cockpit 104 to communicate with the VTOL aerial vehicle. For example, the remote cockpit 104 may communicate with the VTOL aerial vehicle via a radio frequency link. In some embodiments, the remote cockpit 104 may communicate with the VTOL aerial vehicle using the communications network 105. The remote cockpit 104 may provide the input vector to the VTOL aerial vehicle, as previously described with reference to the manned VTOL aerial vehicle 100. In particular, the at least one processor 132 (or the control system 116) may receive the input vector from the remote cockpit 104.

The VTOL aerial vehicle is configured to communicate with the remote cockpit 104 using the communication system 122. The VTOL aerial vehicle may be configured to communicate with the remote cockpit 104 via the radio frequency link and/or the communications network 105. The VTOL aerial vehicle is configured to provide vehicle data to the remote cockpit 104. For example, the VTOL aerial vehicle is configured to provide a video feed and/or telemetry data to the remote cockpit 104. The remote cockpit 104 may comprise a cockpit display configured to display the video feed and/or telemetry data for the pilot.

### Unmanned VTOL Aerial Vehicle

In some embodiments, there is provided an unmanned VTOL aerial vehicle. The unmanned VTOL aerial vehicle may comprise one or more of the features previously described with reference to the manned VTOL aerial vehicle 100. In such a case, the unmanned VTOL aerial vehicle may not include the cockpit 104. Furthermore, the pilot-operable control system 118 may be remote to the unmanned VTOL aerial vehicle. Alternatively, the unmanned VTOL aerial vehicle may be an autonomous unmanned VTOL aerial vehicle.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A manned VTOL aerial vehicle comprising:
a body comprising a cockpit;
a propulsion system carried by the body to propel the body during flight;
pilot-operable controls accessible from the cockpit;
a sensing system configured to generate sensor data associated with a region around the manned VTOL aerial vehicle;
a control system configured to enable control of the manned VTOL aerial vehicle to be shared between a pilot and an autonomous piloting system, the control system comprising:
at least one processor; and
memory accessible to the at least one processor, the memory being configured to store:
the sensor data; and
a three-dimensional model of the region; and
the memory storing program instructions accessible by the at least one processor, and configured to cause the at least one processor to:
determine a state estimate and a state estimate confidence metric, wherein:
the state estimate is indicative of a state of the manned VTOL aerial vehicle within the three-dimensional model;
the state estimate confidence metric is indicative of an error associated with the state estimate; and
the state estimate comprises:
a position estimate that is indicative of a position of the manned VTOL aerial vehicle within the three-dimensional model;
a speed vector that is indicative of a velocity of the manned VTOL aerial vehicle; and
an attitude vector that is indicative of an attitude of the manned VTOL aerial vehicle;
generate a three-dimensional point cloud of the region based at least in part on the sensor data;
generate a plurality of virtual particles within the three-dimensional model at particle positions that are around the state estimate, wherein the particle positions are determined based at least in part on the state estimate confidence metric;
compute a plurality of scores, each score being associated with one of the plurality of virtual particles and being indicative of a difference between the three-dimensional model and the three-dimensional point cloud when the three-dimensional point cloud is centred on the respective virtual particle; and
update the state estimate based at least in part on the computed scores, thereby determining an updated state estimate.

2. The manned VTOL aerial vehicle of claim 1, wherein:
the region comprises an object; and
the program instructions are further configured to cause the at least one processor to control the propulsion system such that the manned VTOL aerial vehicle avoids colliding with the object, based at least in part on the updated state estimate.

3. The manned VTOL aerial vehicle of claim 1, wherein:
the sensing system comprises a Global Navigation Satellite System (GNSS) module configured to generate GNSS data that is indicative of a latitude and a longitude of the manned VTOL aerial vehicle;
the sensor data comprises the GNSS data;
wherein determining the state estimate comprises determining the GNSS date; and
determining the state estimate based at least in part on the GNSS data.

4. (canceled)

5. The manned VTOL aerial vehicle of claim 1, wherein the sensing system comprises one or more of:
an altimeter configured to provide, to the at least one processor, altitude data that is indicative of an altitude of the manned VTOL aerial vehicle;
an accelerometer configured to provide, to the at least one processor, accelerometer data that is indicative of an acceleration of the manned VTOL aerial vehicle;
a gyroscope configured to provide, to the at least one processor, gyroscopic data that is indicative of an orientation of the manned VTOL aerial vehicle; and
a magnetometer sensor configured to provide, to the at least one processor, magnetic field data that is indicative of an azimuth orientation of the manned VTOL aerial vehicle; and
wherein the sensor data comprises one or more of the altitude data, the acceleration data, the gyroscopic data and the magnetic field data;
wherein determining the state estimate comprises:
determining one or more of the altitude data, accelerometer data, gyroscopic data and magnetic field data; and
determining the state estimate based at least in part on one or more of the altitude data, accelerometer data, gyroscopic data and magnetic field data.

6. (canceled)

7. The manned VTOL aerial vehicle of claim 1, wherein:
the sensing system comprises an imaging module configured to provide, to the at least one processor, image data that is associated with the region; and
the sensor data comprises the image data;
wherein the imaging module comprises at least one of:
a light detection and ranging (LIDAR) module configured to rate LIDAR data;
a visible spectrum imaging module configured to generate visible spectrum image data; and
a radio detecting and ranging (RADAR) module configured to rate RADAR data; or
wherein the image data comprises one or more of the LIDAR data, the visible image data and the RADAR data; and
wherein determining the state estimate comprises:
determining one or more of the LIDAR data, visible spectrum image data and RADAR data; and
determining the state estimate based at least part on one or more of the LIDAR data, visible spectrum image data and RADAR data.

8-9. (canceled)

10. The manned VTOL aerial vehicle of claim 1, wherein determining the state estimate and the state estimate confidence metric comprises:
visual odometry;
determining a longitudinal velocity estimate that is indicative of longitudinal velocity of the manned VTOL aerial vehicle, based at least in part on image data captured by a ground-facing camera mounted on the manned VTOL areal vehicle;
determining an egomotion estimate, based at least in part on image data captured by a forward-facing camera mounted on the manned VTOL aerial vehicle
determining an acceleration estimate that is indicative of an acceleration of the manned VTOL arial vehicle, based at least in part on gyroscopic data;
determining an orientation estimate that is indicative of an orientation of the maned VTOL areal vehicle, based at least in part on gyroscopic data;
determining an azimuth orientation estimate of the manned VTOL aerial vehicle, based at least in part on magnetic field data; and
determining an altitude estimate that is indicative of an altitude of the manned VTOL aerial vehicle, bases at least in part on altitude data.

11-12. (canceled)

13. The manned VTOL aerial vehicle of claim 1, wherein the program instructions are further configured to cause the at least one processor to receive external sensing system data generated by an external sensing system, wherein:
the external sensing system data comprises the state estimate and the state estimate confidence metric; and
determining the state estimate and the state estimate confidence metric comprises receiving the external sensing system data.

14-15. (canceled)

16. The manned VTOL aerial vehicle of claim 7, wherein generating the three-dimensional point cloud comprises:
generating a depth map based at least in part on the visible spectrum image data, wherein the depth map is generated using a deep neural network (DNN); and
merging the depth map and the LIDAR data; and
wherein outlier points of the depth map and/or the LIDAR data are excluded from the three-dimensional point cloud.

17-20. (canceled)

21. The manned VTOL aerial vehicle of claim 1, wherein computing one of the plurality of scores comprises determining a comparison metric for each point of the three-dimensional point cloud, wherein the comparison metric is indicative of a distance between the respective point of the three-dimensional point cloud and a comparison point of the three-dimensional model; and
wherein determining the comparison metric for a point of the three-dimensional point cloud comprises:
projecting a ray from the respective particle position of the point of the three-dimensional point cloud; and
determining a distance between the point of the three-dimensional point cloud and a point of the three-dimensional model that is intersected by the ray.

22-23. (canceled)

24. The manned VTOL aerial vehicle of claim 1, wherein updating the state estimate based at least in part on the computed scores comprises:
determining a minimised virtual particle; wherein:
the minimised virtual particle is one of the plurality of virtual particles; and
the score associated with the minimised virtual particle is lower than the scores associated with the other virtual particles of the plurality of virtual particles; and
setting the state estimate to correspond to the minimised virtual particle.

25-51. (canceled)

52. A manned VTOL aerial vehicle comprising:
a body comprising a cockpit;
a propulsion system carried by the body to propel the body during flight;
pilot-operable controls accessible from the cockpit;
a sensing system configured to generate sensor data associated with a region around the manned VTOL aerial vehicle;
a control system configured to enable control of the manned VTOL aerial vehicle to be shared between a pilot and an autonomous piloting system, the control system comprising:
at least one processor; and
memory accessible to the at least one processor, the memory being configured to store the sensor data; and
the memory storing program instructions accessible by the at least processor, and configured to cause the at least one processor to:
determine an initial state estimate indicative of a state of the manned VTOL aerial vehicle within the region at a first time;
determine that GNSS data is unavailable; and
in response to determining that GNSS data is unavailable:
determine a motion estimate that is indicative of motion of the VTOL aerial vehicle between the first time and a second time, based at least in part on the sensor data; and
determine an updated state estimate based at least in part on the motion estimate and the initial state estimate.

53. The manned VTOL aerial vehicle of claim 52, wherein:
the region comprises an object; and
the program instructions are further configured to cause the at least one processor to control the propulsion system such that the manned VTOL aerial vehicle avoids colliding with the object, based at least in part on the updated state estimate.

54. The manned VTOL aerial vehicle of claim 52, wherein the initial state estimate comprises:
an initial position estimate that is indicative of a position of the manned VTOL aerial vehicle within the region at the first time;
an initial speed vector that is indicative of a velocity of the manned VTOL aerial vehicle at the first time; and
an initial attitude vector that is indicative of an attitude of the manned VTOL aerial vehicle at the first time.

55. The manned VTOL aerial vehicle of claim 52, wherein the updated state estimate comprises:
an updated position estimate that is indicative of an updated position of the manned VTOL aerial vehicle within the region at the second time;
an updated speed vector that is indicative of an updated velocity of the manned VTOL aerial vehicle at the second time; and
an updated attitude vector that is indicative of an updated attitude of the manned VTOL aerial vehicle at the second time.

56. The manned VTOL aerial vehicle of claim 52, wherein the motion estimate comprises:
a motion estimate position estimate that is indicative of a change in position of the manned VTOL aerial vehicle between the first time and the second time;
a motion estimate speed vector that is indicative of a change in velocity of the manned VTOL aerial vehicle between the first time and the second time; and
a motion estimate attitude estimate that is indicative of a change in attitude of the manned VTOL aerial vehicle between the first time and the second time.

57. The manned VTOL aerial vehicle of claim 52, wherein:
the sensing system comprises a Global Navigation Satellite System (GNSS) module configured to generate GNSS data that is indicative of a latitude and a longitude of the manned VTOL aerial vehicle;
the sensor data comprises the GNSS data;
wherein the GNSS data is available at the first time and the GNSS data is unavailable at the second time; and
wherein determining the initial state estimate comprises:
determining the GNSS data; and
determining the initial state estimate based at least in part on the GNSS data.

58-59. (canceled)

60. The manned VTOL aerial vehicle of claim 52, wherein the sensing system comprises one or more of:
an altimeter configured to provide, to the at least one processor, altitude data that is indicative of an altitude of the manned VTOL aerial vehicle;
an accelerometer configured to provide, to the at least one processor, accelerometer data that is indicative of an acceleration of the manned VTOL aerial vehicle;
a gyroscope configured to provide, to the at least one processor, gyroscopic data that is indicative of an orientation of the manned VTOL aerial vehicle; and
a magnetometer sensor configured to provide, to the at least one processor, magnetic field data that is indicative of an azimuth orientation of the manned VTOL aerial vehicle; and
wherein the sensor data comprises one or more of the altitude data, the acceleration data, the gyroscopic data and the magnetic field data.

61. (canceled)

62. The manned VTOL aerial vehicle of claim 52, wherein:
the sensing system comprises an imaging module configured to provide, to the at least one processor, image data that is associated with the region; and
the sensor data comprises the image data;
wherein the imaging module comprises at least one of:
a light detection and ranging (LIDAR) module configured to rate LIDAR data;
a visible spectrum imaging module configured to generate visible spectrum image data; or
a radio detecting and ranging (RADAR) module configured to generate RADAR data; and
wherein the image data comprises one or more of the LIDAR data, the visible image data and the RADAR data; and
wherein determining the motion estimate comprises:
determining one or more of the LIDAR data, the visible spectrum image data and the RADAR data at the first time;
determining one or more of the LIDAR data, the visible spectrum image data and the RADAR data at the second time; and
determining the motion estimate based at least part on one or more of the LIDAR data, the visible spectrum image data and the RADAR data at the first time and one or more of the LIDAR data, the visible spectrum image data and the RADAR data at the second time.

63-64. (canceled)

65. The manned VTOL aerial vehicle of claim 52, wherein determining the motion estimate comprises:
visual odometry;
determining a longitudinal velocity estimate that is indicative of longitudinal velocity of the manned VTOL aerial vehicle, based at least in part on image data captured by a ground-facing camera mounted on the manned VTOL areal vehicle;
determining an egomotion estimate, based at least in part on image data captured by a forward-facing camera mounted on the manned VTOL aerial vehicle
determining an acceleration estimate that is indicative of an acceleration of the manned VTOL arial vehicle, based at least in part on gyroscopic data;
determining an orientation estimate that is indicative of an orientation of the maned VTOL areal vehicle, based at least in part on gyroscopic data;
determining an azimuth orientation estimate of the manned VTOL aerial vehicle, based at least in part on magnetic field data; and
determining an altitude estimate that is indicative of an altitude of the manned VTOL aerial vehicle, bases at least in part on altitude data.

66-68. (canceled)

69. The manned VTOL aerial vehicle of claim 52, wherein determining the updated state estimate comprises adding the motion estimate to the initial state estimate.

70-85. (canceled)
